(19) United States
(12) Patent Application Publication
(10) Pub. No.: US 2008/0317702 A1
(43) Pub. Date: Dec. 25, 2008

(54) METHOD FOR TREATING MICROORGANISMS AND/OR INFECTIOUS AGENTS

(76) Inventors: Garry Edgington, Honolulu, HI (US); Snezna Rogeli, Socorro, NM (US); Hong Tang, Socorro, NM (US); Scott Shors, Socorro, NM (US); Michael Patrick O'Neill, Kaneohe, HI (US); Krista Eve Peksa, Ewa Beach, HI (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/142,018

(22) Filed: Jun. 19, 2008

Related U.S. Application Data
(60) Provisional application No. 60/944,838, filed on Jun. 19, 2007.

(51) Int. Cl. A01N 37/00; A01N 25/00; A01P 1/00

(52) U.S. Cl. 424/78.18; 424/78.08; 424/78.31; 424/78.35

(57) ABSTRACT

This invention relates to a method comprising contacting a microorganism and/or an infectious agent with an effective amount of a polymer composition to reduce or eliminate the reproductivity, metabolism, growth and/or pathogenicity of the microorganism and/or infectious agent, the polymer composition comprising water, a water-soluble film forming polymer, a chelating agent, and a surfactant.

This application claims priority under 35 U.S.C. §119(e) to U.S. Provisional Application Ser. No. 60/944,838 filed Jun. 19, 2007. This prior application is incorporated herein by reference.

### TECHNICAL FIELD

This invention relates to a method for treating microorganisms and/or infectious agents. More particularly, this invention relates to a method of reducing or eliminating the reproductivity, metabolism, growth and/or pathogenicity of a microorganism and/or an infectious agent.

### BACKGROUND

Abatement methods for removing a contaminant from a surface typically involve applying a liquid-state composition to the surface in contact with the contaminant, allowing the liquid-state composition to solidify into a solid-state matrix wherein the contaminant is sequestered by the matrix, and then removing the solid-state matrix from the surface.

### SUMMARY

A problem with many abatement methods is that when removing biological materials, such as microorganisms and/or infectious agents, the biological materials, although sequestered, may still be alive or active and thereby remain problematic. This invention provides a solution to this problem. This invention relates to a method wherein microorganisms and/or infectious agents are contacted with a polymer composition for an effective period of time to reduce or eliminate the reproductivity, metabolism, growth and/or pathogenicity of the microorganism and/or infectious agent. That is, the microorganism and/or infectious agent may be killed or inactivated as a result of treatment in accordance with the inventive method. The inventive method may involve sequestering the microorganism and/or infectious agent. However, since the microorganism and/or infectious agent may be killed or inactivated with the inventive method, sequestering may not be required.

The inventive method comprises contacting a microorganism and/or an infectious agent with an effective amount of a polymer composition to reduce or eliminate the reproductivity, growth and/or pathogenicity of the microorganism and/or infectious agent, the polymer composition comprising water, a water-soluble film forming polymer, a chelating agent, and a surfactant. The polymer may comprise repeating units derived from vinyl alcohol and/or (meth)acrylic acid (i.e., repeating units derived from acrylic acid, methacrylic acid, or a mixture thereof.

The invention, in one embodiment, relates to a method comprising: contacting a microorganism and/or an infectious agent with an effective amount of a polymer composition to reduce or eliminate the reproductivity, metabolism, growth and/or pathogenicity of the microorganism and/or infectious agent; the polymer composition comprising water, a water-soluble film forming polymer, a chelating agent, and a surfactant; the polymer composition being characterized by the absence of an effective amount of an added biocide, viricide and/or fungicide to reduce or eliminate the reproductivity, metabolism and/or growth of the microorganism and/or infectious agent.

The invention, in one embodiment, also relates to a method, comprising: contacting a substrate with a polymer composition comprising water, a water-soluble film forming polymer, a chelating agent, and a surfactant; drying the polymer composition to form a polymer film adhered to the substrate; separating the polymer film from the substrate; forming a biofilm on the substrate; and separating the biofilm from the substrate. The biofilm may exhibit a reduction or elimination of its reproductivity, metabolism, growth and/or pathogenicity as a result of residual antimicrobial and/or bactericidal activity provided for the substrate by the polymer film.

This invention, in one embodiment, relates to a method, comprising: contacting a substrate with a polymer composition comprising water, a water-soluble film forming polymer, a chelating agent, and a surfactant; drying the polymer composition to form a polymer film adhered to the substrate; forming a biofilm on the polymer film; and separating the biofilm from the polymer film or separating the biofilm and the polymer film from the substrate.

The inventive method employs the use of a polymer composition that provides an antimicrobial functionality, including sporicidal activity. The polymer composition may be safe and user friendly. The polymer composition may be in the form of a hydrogel. The polymer composition may dry or dehydrate to a thin layer of film which may be subsequently removed by peel-off or wash-off. The inventive method may be used to provide an anti-bacterial treatment for contaminated surfaces. The dried or dehydrated film may be re-hydrated for DNA forensic analysis and bio-agent identification. The inventive method may be used for biological decontamination applications. The inventive method may be used for killing or inactivating spores, including Bacillus subtilis which is a surrogate for the anthrax bacterium B. Anthracis; and numerous pathogenic bacteria, including E. coli O157:H7, S. aureus (MRSA), which is a source of hard to treat, hospital acquired infection, and E. faecalis (VRE) and A. Baumanii, which are bacterial agents of increasing numbers of infections found in veterans of the Iraq War. The inventive method may be used for killing or inactivating biofilms, viruses, fungi, and the like. Surfaces remaining after the peeling or washing off of the dried or dehydrated film may be sterile and characterized by residual antimicrobial and/or bactericidal activity. The polymer composition used with the inventive method may be approximately 100 times less toxic to human cells than bacteriostatic mouthwash.

### BRIEF DESCRIPTION OF THE DRAWINGS

FIG. 1 shows restriction fragment patterns for the bacteria tested in Example 20.

FIGS. 2 and 3 show a comparison of the polymer composition from Example 1 (FIG. 2) and chlorohexidine gluconate (FIG. 3) to HeLa cells as described in Example 23.

FIG. 4 shows the inhibitory affect of the polymer composition from Example 1 as it leaches out of a solid material as described in Example 26.

FIG. 5 shows the results of the polymer from Example 1 leaching out of a solid support to protect the surrounding area against proliferation of unknown sewage bacteria as described in Example 27.

FIG. 6 shows the killing of bacterial spores and prevention of germinated B. subtilis bacteria as described in Example 28.

### DETAILED DESCRIPTION

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural. All combinations specified in the claims may be combined in any manner.

The term “microorganism” generally refers to any living organism that is microscopic (too small to be seen by the naked eye). The term microorganism may also include living organisms such as fungi, and the like, that are technically not microscopic, due to the fact that they may be seen by the naked eye, but may have dimensions up to about 1 millimeter, and in one embodiment in the range from about 0.1 micron to about 1 millimeter, and in one embodiment in the range from about 0.1 to about 750 microns. The microorganism may be unicellular or multicellular. The microorganism may include bacteria, rickettsia, protozoa, fungi, or a mixture of two or more thereof. The microorganism may secrete potentially lethal endotoxins when lysed or soluble exotoxins. The microorganism may include microscopic plants and animals such as plankton, planarian, amoeba, and mixtures of two or more thereof. The microorganisms may include anthropods such as dust mites, spider mites, and the like. The microorganism may be an infectious agent.

The term “infectious agent” refers to a biological material that causes disease or illness to its host. The infectious agent may be a pathogen. The infectious agent may comprise a drug-resistant pathogen, such as a multidrug resistant Staphylococcus aureus (MRSA). The infectious agent may comprise a pathogen in its vegetative or spore form of life-cycle. The infectious agent may comprise a microorganism, virus, prion, or mixture of two or more thereof.

The terms “contaminant” or “contaminant material” are used herein to refer to a microorganism and/or infectious agent which may be treated in accordance with the inventive method.

The term “spore” refers to a differentiated developmental structure that is adapted for dispersion and surviving for extended periods of time in unfavorable conditions. Spores form part of the life cycle of many plants, algae, fungi and protozoan. The spores may include bacterial spores.

The term “bacteria” refers to unicellular microorganisms. The bacteria species may be eubacteria, cyanobacteria or archaebacteria. Bacteria may be prokaryotes, typically up to about one micron in length. Individual bacteria may have a wide range of shapes including spheres to rods to spirals. Bacteria may be Gram-positive or Gram-negative. Gram-positive bacteria possess a thick wall containing layers of peptidoglycan and teichoic acids. Gram-negative bacteria have a thin cell wall consisting of a few layers of peptidoglycan surrounded by a second lipid membrane containing lipopolysaccharides and lipoproteins. Some bacteria require an eukaryotic host for replication, some form spores, and some may form or participate in biofilm formation.

The term “biofilm” refers to an aggregation of microorganisms floating on a liquid or attached to a surface. These films may range from a few micrometers to meters in thickness and width, and may contain multiple species of bacteria, protists, archaea, and the like. Bacteria living in biofilms may display a complex arrangement of cells and protective extracellular components, forming secondary structures such as (micro)colonies, through which there may be networks of channels to enable better diffusion of nutrients. The complex extracellular matrix (composed mostly of carbohydrate, proteins, deoxyribonucleic acid (DNA) but varying in composition from one biofilm to another) protects the resident bacteria from environmental changes and assaults such as dramatic changes in pH and oxygen level, dehydration, sheer stress, toxic chemicals such as oxidants (e.g. Clorox) and antibiotics. Biofilm bacteria may exhibit decreased sensitivity to biocides and antibiotics, in some cases becoming 1000 fold more resistant to an antibiotic or biocide than the same type of bacteria grown in planktonic culture. Biofilms may be found widespread in the environment (e.g. hot springs), on household furnishings (e.g. shower curtains, kitchen sinks, heat exchangers), devices (e.g. filtration membranes), medical instrumentation (e.g. urinary catheters), contact lenses and artificial implants (e.g., pacemakers, stents, dental and breast implants, heart-valves, and the like), and on and within human bodies. Biofilms may be a major cause of human disease including bladder infections, colitis and conjunctivitis. These biofilms are highly resistant both to clearance by the immune system and to antibiotic treatments. Biofilms may serve as a continuous source of planktonic bacteria, which, when released from the biofilms, seed formation of new biofilms. In cases where the resident bacteria are pathogenic or infectious agents, the biofilm sloughed-off materials may seed the circulatory system and surrounding tissues with the planktonic bacteria or biofilm microcolonies and thus set off acute infections.

The term “fungi” refers to heterotrophic organisms often possessing a chitinous cell wall. The majority of species grow as multicellular filaments called hyphae forming a mycelium; some fungal species also grow as single cells. Sexual and asexual reproduction of the fungi is commonly via spores, often produced on specialized structures or in fruiting bodies. Some species have lost the ability to form specialized reproductive structures, and propagate solely by vegetative growth. Yeasts and molds are examples of fungi. Fungus is a eukaryotic organism that is a member of the kingdom Fungi.

The term “yeast” refers to a growth form of eukaryotic microorganisms classified in the kingdom Fungi, with about 1,500 species described in the literature. Most reproduce asexually by budding, although a few do so by binary fission. Yeasts are unicellular, although some species with yeast forms may become multicellular via cellular aggregation and be known as molds. Yeast size can vary greatly depending on the species, typically measuring 3-4 μm in diameter, although some yeasts can reach over 40 μm. Yeasts may also form biofilms which may include other microorganisms. Yeast biofilms may form in a variety of different environments, including medical implants. Yeast biofilms may be pathogenic.

The term “mold” refers to species of microscopic fungi that grow in the form of multicellular filaments called hyphae. In contrast, microscopic fungi that grow as single cells are called yeasts. A connected network of these tubular branching hyphae may have multiple, genetically identical nuclei and be considered to be a single organism.

The term “virus” refers to a sub-microscopic infectious agent that is unable to grow or reproduce outside a host cell. Each viral particle, or viron, consists of genetic material, DNA or ribonucleic acid (RNA), within a protective protein coat called a capsid. The capsid shape may vary from simple geometric structures to more complex structures with tails or an envelope. Viruses may infect specific cellular life forms and are grouped into animal, plant and bacterial types, according to the type of host cell that they infect.

The term “prion” refers to an infectious agent that is composed entirely of certain proteins. These prion proteins may exist in a normal conformation (shape) or in an altered, abnormal conformation. It is the shape of the abnormal, mis-folded prion proteins that is infectious. This misfolded shape renders the prion proteins highly resistant to inactivation via heat, pH, chemicals and enzymes. Misfolded prions cause a number of diseases in a variety of mammals, including bovine spongiform encephalopathy (BSE, also known as “mad cow disease”) in cattle and acquired Creutzfeldt-Jakob disease (CJD) in humans. In mammals, the prion diseases affect the brain and/or other neural tissue, and all prion-caused diseases are currently untreatable and may be fatal. In general usage, the term prion may refer to either the theoretical unit of infection or the specific protein (e.g., PrP) that is thought to be the infective agent, whether or not it is in an infective conformation state.

The term “rickettsia” refers to a gram-negative, non-spore forming bacteria that depends upon the eukaryotic host cell for growth and replication. This bacteria may be referred to as being non-motile. This bacteria cannot live in artificial nutrient environments. Rickettsia are carried as parasites in a vector (e.g., fleas, ticks) to the host. Rickettsia are known to cause a number of diseases in plants and animals, such as Rocky Mountain spotted fever and Typhus. They may be referred to as being microorganisms positioned between viruses and bacteria.

The term “protist” refers to a diverse group of organisms comprising eukaryotes that cannot be classified in any of the other eukaryotic kingdoms as fungi, animals, or plants.

The term “water-soluble” refers to a material that is soluble in water at a temperature of 20° C. to the extent of at least about 5 grams of the material per liter of water. The term “water-soluble” may also refer to a material that forms an emulsion in water.

The term “water-soluble film forming polymer” refers to a polymer which may be dissolved in water and upon evaporation of the water forms a film or coating layer.

The term “biodegradable” refers to a material that degrades to form water and CO₂.

The terms “dehydrating” and “drying” may be used interchangeably.

The microorganisms and/or infectious agents that may be treated in accordance with the inventive method may be referred to as contaminants. The microorganism and/or infectious agent may comprise bacteria, biofilm, metazoa, or a mixture of two or more thereof. The microorganism and/or infectious agent may comprise bacteria, fungus, yeast, yeast biofilm, mold, protists, or a mixture of two or more thereof. The microorganism and/or infectious agent may comprise one or more spores. The microorganism and/or infectious agent that may be treated may comprise a pathogen. The microorganism and/or infectious agent may comprise a virus, prion, rickettsia, or a mixture of two or more thereof.

The microorganisms and/or infectious agents may comprise one or more biological warfare agents. The microorganisms and/or infectious agents may comprise any microorganism and/or infectious agent that is encountered through contact with other humans or through contact with contaminated surfaces such as those in hospitals and the like. The microorganism and/or infectious agent may comprise one or more bacterial spores, vegetative bacteria, or biofilms. The microorganisms and/or infectious agents may be capable of killing or causing severe injury to mammals, particularly humans. These may include viruses, such as equine encephalomyelitis and smallpox, the coronavirus responsible for Severe Acute Respiratory Syndrome (SARS), herpes virus, hepatitis virus, and the like. These may include bacteria, such as those which cause plague (Yersina pestis), anthrax (Bacillus anthracis), tularemia (Francisella tularensis), wound or lung infections (e.g. Staphylococcus aureus (including multi-drug-resistant S. aureus MRSA, Pseudomonas aeruginosa (potential biofilm former)), contaminate foods (Escherichia coli (E. coli 0157-H7)), or Enterococcus faecalis, including Vancomycin resistant Enterococcus (VRE). The microorganisms and/or infectious agents may include fungi, which, among others include the dimorphic fungus Coccidioides which may cause coccidioidomycosis, Candida albicans which may cause the wide-spread Candidiasis (that can be life threatening, particularly in an immunocompromised patient) or Aspergillus which may cause a wide spectrum of human diseases. The microorganisms and/or infectious agents may include toxic products produced by such microorganisms; for example, the botulism toxin (BT) expressed by the Clostridium botulinium bacterium. The microorganisms and/or infectious agents may include those responsible for the common cold (rhinoviruses), warts and pre-disposition to cancer (pappilloma virus), influenza (orthomyxoviruses), skin abscesses, toxic shock syndrome (Staphylococcus aureus), bacterial pneumonia (Streptococcus pneumoniae), stomach upsets (Escherichia coli, Salmonella), and the like. The microorganisms and/or infectious agents that may be treated may comprise one or more of Escherichia coli, Staphylococcus epidermidis, Staphylococcus aureus, Burkholderia cepacia, Bacillus subtilis, Enterococcus faecalis, Pseudomonas aeruginosa, Streptococcus pyogenes, Acinetobacter baumannii, or Candida albicans. These microorganisms may be antibiotic/drug resistant such as S. aureus MRSA, MDR A. baumannii and VRE E. faecalis), and/or may be biofilm-forming organisms (e.g. Pseudomonas aeruginosa), and/or may be spore-forming organisms (e.g. B. subtilis, B. anthracis, and Clostridium spp.)

The microorganisms and/or infectious agents that may be treated may comprise one or more of Escherichia coli, Escherichia coli 0157-H7, Staphylococcus epidermidis, Staphylococcus epidermidis biofilms, Staphylococcus aureus, Staphylococcus aureus MRSA, Burkholderia cepacia, Bacillus subtilis, Enterococcus faecalis, Enterococcus faecalis-VRE, Pseudomonas aeruginosa, Pseudomonas aeruginosa biofilms, Streptococcus pyogenes, Acinetobacter baumannii, Candida albicans, or Candida albicans biofilms.

The polymer composition may comprise water, at least one water-soluble film forming polymer, at least one chelating agent, and at least one surfactant. The polymer may comprise repeating units derived from vinyl alcohol and/or (meth)acrylic acid. The polymer may comprise polyvinyl alcohol, a copolymer of vinyl alcohol, or a mixture thereof. The term “copolymer” may be used herein to refer to a polymer with two or more different repeating units including copolymers, terpolymers, and the like.

The polymer may comprise an atactic polyvinyl alcohol. These polymers may have a semicrystalline character and a strong tendency to exhibit both inter-molecular and intra-molecular hydrogen bonds.

The polymer may comprise repeating units represented by the formula —CH₂—CH(OH)— and repeating units represented by the formula —CH₂—CH(OCOR)— wherein R is an alkyl group. The alkyl group may contain from 1 to about 6 carbon atoms, and in one embodiment from 1 to about 2 carbon atoms. The number of repeating units represented by the formula —CH₂—CH(OCOR)— may be in the range from about 0.5% to about 25% of the repeating units in the polymer, and in one embodiment from about 2 to about 15% of the repeating units. The ester groups may be substituted by acetaldehyde or butyraldehyde acetals.

The polymer may comprise a poly(vinyl alcohol/vinyl acetate) structure. The polymer may be in the form of a vinyl alcohol copolymer which also contains hydroxyl groups in the form of 1,2-glycols, such as copolymer units derived from 1,2-dihydroxyethylene. The copolymer may contain up to about 20 mole % of such units, and in one embodiment up to about 10 mole % of such units.

The polymer may comprise a copolymer containing repeating units derived from vinyl alcohol and/or (meth)acrylic acid, and repeating units derived from one or more of vinyl acetate, ethylene, propylene, acrylic acid, methacrylic acid, acrylamide, methacrylamide, dimethacrylamide, hydroxyethylmethacrylate, methyl methacrylate, methyl acrylate, ethyl acrylate, vinyl pyrrolidone, hydroxyethylacrylate, hydroxymethylcellulose, hydroxethylcellulose, allyl alcohol, and the like. The copolymer may contain up to about 50 mole % of repeating units other than those of vinyl alcohol, and in one embodiment from about 1 to about 20 mole % of such repeating units other than vinyl alcohol.

Polyvinyl alcohols that may be used include those available under the tradenames Celvol 523 from Celanese (MW=85,000 to 124,000, 87-89% hydrolyzed), Celvol 508 from Celanese (MW=50,000 to 85,000, 87-89% hydrolyzed), Celvol 325 from Celanese (MW=85,000 to 130,000, 98-98.8% hydrolyzed), Vinol® 107 from Air Products (MW=22,000 to 31,000, 98-98.8% hydrolyzed), Polysciences 4397 (MW=25,000, 98.5% hydrolyzed), BF 14 from Chan Chun, Elvanol® 90-50 from DuPont and UF-120 from Unitika. Other producers of polymers that may be used may include Nippon Gohsei (Gohsenol®), Monsanto (Gelvatol®), Wacker (Polyviol®) or the Japanese producers Kuraray, Deriki, and Shin-Etsu.

The polymer may have a hydrolysis level in the range from about 70% to about 100%, and in one embodiment from about 70% to about 99.3%, and in one embodiment in the range from 70% to about 95%, and in one embodiment from about 70% to about 90%, and in one embodiment from about 87% to about 89%.

The polymer may comprise repeating units derived from one or more (meth)acrylic acids (i.e. acrylic acid and/or methacrylic acid). These may include linear, crosslinked, lightly crosslinked, neutralized and/or partially neutralized forms of the polymer. These may be available under the name Polyacrylic Acid 5100 from Hampton Research; Poly(acrylic acid), which is a partial sodium salt, lightly crosslinked polymer available from Sigma Aldrich; Poly(acrylic acid) from Polysciences, Inc (MW ˜90000 g/mol); and Poly(Acrylic Acid) from Polysciences Inc (MW:˜100000 g/mol). Polymethacrylic acids that may be used may include those available under tradenames Poly(methacrylic acid solution salt) from Sigma Aldrich (MW: ˜429,000 to 549,000 g/mol), and Poly Methacrylic Acid (25087-26-7) from Polysciences Inc (MW: ˜100,000 g/mol).

The polymer may have a weight average molecular weight of at least about 5,000 g/mol. The polymer may have a weight average molecular weight of up to about 2,000,000 g/mol. The polymer may have a weight average molecular weight in the range from about 5000 to about 2,000,000, and in one embodiment in the range from about 10,000 to about 1,000,000 g/mol, and in one embodiment from about 10,000 to about 600,000, and in one embodiment from about 10,000 g/mol to about 250,000 g/mol, and in one embodiment from about 10,000 g/mol to about 190,000 g/mol, and in one embodiment in the range from about 10,000 to about 150,000 g/mole, and in one embodiment in the range from about 50,000 to about 150,000 gl/mole, and in one embodiment in the range from about 85,000 to about 125,000 g/mole.

The concentration of the polymer in the polymer composition (before drying or dehydrating) may be in the range from about 0.5 to about 50% by weight, and in one embodiment from about 1 to about 25% by weight, and in one embodiment in the range from about 1 to about 20% by weight, and in one embodiment in the range from about 2 to about 10% by weight.

The polymer composition may have a concentration of water (before drying or dehydrating) in the range from about 40 to about 99% by weight, and in one embodiment from about 60 to about 95% by weight. The water may be derived from any source. The water may comprise deionized or distilled water. The water may comprise tap water. The water may comprise sterile nanopure water.

The chelating agent, or chelant, may comprise one or more organic or inorganic compounds that contain two or more electron donor atoms that form coordinate bonds to metal ions or other charged particles. After the first such coordinate bond, each successive donor atom that binds may create a ring containing the metal or charged particle. The structural aspects of a chelate may comprise coordinate bonds between a metal or charged particle, which may serve as an electron acceptor, and two or more atoms in the molecule of the chelating agent, or ligand, which may serve as the electron donors. The chelating agent may be bidentate, tridentate, tetradentate, pentadentate, and the like, according to whether it contains two, three, four, five or more donor atoms capable of simultaneously complexing with the metal ion or charged particle.

The chelating agent may comprise an organic compound that contains a hydrocarbon linkage and two or more functional groups. The same or different functional groups may be used in a single chelating agent. The functional groups may comprise ═O, —OR, —NR₂, —NO₂, ═NR, ═NOR, and/or ═N—R*-OR, wherein R is H or alkyl; and R* is alkylene. The functional groups may comprise phosphate and/or phosphonate groups. The alkyl groups may contain from 1 to about 10 carbon atoms, and in one embodiment from 1 to about 4 carbon atoms. The alkylene groups may contain from 2 to about 10 carbon atoms, and in one embodiment from 2 to about 4 carbon atoms. The chelating agent may comprise one or more of ethylenediaminetetraacetic acid (EDTA), diethylenetriaminepentaacetic acid (DTPA), prussian blue, citric acid, peptides, amino acids including short chain amino acids, aminopolycarboxylic acids, gluconic acid, glucoheptonic acid, organophosphonates, bisphosphonates such as pamidronate, inorganic polyphosphates, and the like. Salts of one or more of the foregoing chelating agents may be used. These may include sodium, calcium and/or zinc salts of the foregoing. The sodium, calcium and/or zinc salts of DTPA may be used. Salts of the foregoing chelating agents may be formed when neutralizing the agent with, for example, sodium hydroxide. Mixtures of two or more of any of the foregoing may be used.

The concentration of the chelating agent in the polymer composition (before drying or dehydrating) may be in the range from about 0.1 to about 5% by weight, and in one embodiment from about 0.5 to about 2% by weight.

The surfactant may comprise one or more ionic and/or nonionic compounds having a hydrophilic lipophilic balance (HLB) in the range of zero to about 18 in Griffin's system, and in one embodiment from about 0.01 to about 18. The ionic compounds may be cationic or amphoteric compounds. Examples may include those disclosed in McCutcheons Surfactants and Detergents, 1998, North American & International Edition. Pages 1-235 of the North American Edition and pages 1-199 of the International Edition are incorporated herein by reference for their disclosure of such surfactants. The surfactants that may be used may comprise one or more polysiloxanes, alkanolamines, alkylarylsulfonates, amine oxides, poly(oxyalkylene) compounds, including block copolymers comprising alkylene oxide repeat units, carboxylated alcohol ethoxylates, ethoxylated alcohols, ethoxylated alkyl phenols, ethoxylated amines and amides, ethoxylated fatty acids, ethoxylated fatty esters and oils, fatty esters, fatty acid amides, glycerol esters, glycol esters, sorbitan esters, imidazoline derivatives, lecithin and derivatives, lignin and derivatives, monoglycerides and derivatives, olefin sulfonates, phosphate esters and derivatives, propoxylated and ethoxylated fatty acids or alcohols or alkyl phenols, sorbitan derivatives, sucrose esters and derivatives, sulfates or alcohols or ethoxylated alcohols or fatty esters, sulfates or sulfonates of dodecyl and tridecyl benzenes or condensed naphthalenes or petroleum, sulfosuccinates and derivatives, tridecyl and/or dodecyl benzene sulfonic acids, and/or poly(dimethylsiloxane). Mixtures of two or more of the foregoing may be used. The surfactant may comprise a centrimonium cation, a hexadecyltrimethylammonium cation (HDTMA), or a mixture thereof. The surfactant may comprise sodium dodecyl sulfate (SDS), sodium lauryl sulfate, cetyltrimethylammonium bromide, cetyltrimethyl ammonium chloride, hexadecyl trimethyl ammonium bromide, hexadecyl trimethyl ammonium chloride, or a mixture of two or more thereof.

The concentration of the surfactant in the polymer composition (before drying or dehydrating) may be in the range from about 0.05 to about 10% by weight of the composition, and in one embodiment in the range from about 0.1 to about 5% by weight, and in one embodiment from about 0.1 to about 2% by weight.

The polymer composition may further comprise one or more crosslinkers, soaps, detergents, thixotropic additives, pseudoplastic additives, rheology modifiers, anti-settling agents, anti-sagging agents, leveling agents, defoamers, colorants, organic solvents, plasticizers, viscosity stabilizers, biocides, viricides, fungicides, chemical warfare agent neutralizers, humectants, or a mixture of two or more thereof.

The crosslinker may comprise sodium tertraborate, glyoxal, Sunrez 700 (a product of Sequa Chemicals identified as a cyclic urea/glyoxal/polyol condensate), Bacote-20 (a product of Hopton Technology identified as a stabilized ammonium zirconium carbonate), polycup-172 (a product of Hercules, Inc. identified as a polyamide-epichlorohydrin resin), or a mixture of two or more thereof.

The soap may comprise a surfactant that may be used with water for washing or cleaning. The soap may be a salt of a fatty acid. The soap may be made by reacting a fat with an alkali such as sodium hydroxide, sodium carbonate or potassium hydroxide. The reaction may be saponification wherein the alkali and water hydrolyze the fat to convert it into free glycerol/glycerin and fatty acid salt.

The detergent may comprise a composition that may be used to assist cleaning. The detergent may comprise the combination of one or more soaps, surfactants, abrasives, pH modifiers, water softeners, oxidants, non-surfactant materials that keep contaminants in suspension, enzymes, foam stabilizers, brighteners, fabric softeners, perfumes, corrosion inhibitors, preservatives, and the like.

The thixotropic additive may comprise one or more compounds that enables the polymer composition to thicken or stiffen in a relatively short period of time on standing at rest but, upon agitation or manipulation (e.g., brushing, rolling, spraying) to flow freely. The thixotropic additive may comprise fumed silica, treated fumed silica, clay, hectorite clay, organically modified hectorite clay, thixotropic polymers, pseudoplastic polymers, polyurethane, polyhydroxycarboxylic acid amides, modified urea, urea modified polyurethane, or a mixture of two or more thereof. A thixotropic additive that may be used is Byk-420 which is a product of Chemie identified as a modified urea.

The leveling agent may comprise polysiloxane, dimethylpolysiloxane, polyether modified dimethylpolysiloxane, polyester modified dimethylpolysiloxane, polymethylalkysiloxane, aralkyl modified polymethylalkylsiloxane, alcohol alkoxylates, polyacrylates, polymeric fluorosurfactants, fluoro modified polyacrylates, or a mixture of two or more thereof.

The colorant may comprise one or more dyes, pigments, and the like. These may include Blue Food Color Formula # 773389 from McCormick and Company Inc., and/or Spectrazurine Blue FND-C LIQ from Spectra Colors Corp. The colorant may comprise one or more dyes that become fluorescent upon drying or in response to a change in pH.

The organic solvent may comprise one or more alcohols, for example, methanol, ethanol, propanol, butanol, one or more ketones, for example, acetone, one or more acetates, for example, methyl acetate, or a mixture of two or more thereof.

The plasticizer may comprise ethylene glycol, polyethylene glycol, propylene glycol, polypropylene glycol, butane diol, polybutylene glycol, glycerine, or a mixture of two or more thereof.

The viscosity stabilizer may comprise a mono or multifunctional hydroxyl compound. These may include methanol, ethanol, propanol, butanol, ethylene glycol, polyethylene glycol, propylene glycol, polyethylene glycol, propylene glycol, polypropylene glycol, butane diol, polybutylene glycol, glycerine, or a mixture of two or more thereof.

The biocide, viricide or fungicide may have the capability of killing or inactivating common biological contaminates. The biocide, viricide or fungicide may comprise sodium hypochlorite, potassium hypochlorite, pH-amended sodium hypochlorite, quaternary ammonium chloride, pH-amended bleach (Clorox®), CASCAD™ surface decontamination foam (AllenVanguard), DeconGreen (Edgewood Chemical Biological Center), DioxiGuard (Frontier Pharmaceutical), EasyDecon 200 (Envirofoam Technologies), Exterm-6 (ClorDiSys Solutions), HI-Clean 605 (Howard Industries), HM-4100 (Biosafe) KlearWater (Disinfection Technology), Peridox (Clean Earth Technologies) Selectrocide (BioProcess Associates), EasyDECON™ 200 decontamination solution or a mixture of two or more thereof. The biocide may comprise Kathon LX (a product of Rohm and Hass Company comprising 5-chloro-2-methyl-4-isothiazolin-3-one and 2-methyl-4-isothiazolin-3-one) or Dowacil 75 (a product of Dow Chemical comprising 1-(3-chloroallyl)-3,5,7-triaza-1-azoniaadamantane chloride described as being useful as a preservative for antimicrobial protection).

Although with various embodiments of the invention it may be advantageous to include one or more biocides, viricides and/or fungicides in the polymer composition, it is not necessary to include such biocides, viricides and/or fungicides in the polymer composition in order to reduce or eliminate reproductivity, metabolism, growth and/or pathogenicity of the microorganisms and/or infectious agents. This is shown in the examples below. Thus, in one embodiment, the polymer composition used with the inventive method may be characterized by the absence of an effective amount of an added biocide, viricide and/or fungicide to reduce or eliminate the reproductivity, metabolism, growth and/or pathogenicity of the microorganism and/or infectious agent being treated.

The chemical warfare agent neutralizers may comprise potassium permanganate, potassium peroxydisulfate, potassium peroxymonosulfate (Virkon S®), potassium molybdate, hydrogen peroxide, chloroisocyanuric acid salt, sodium hypochlorite, potassium hypochlorite, pH-amended sodium hypochlorite, hydrogen peroxide, oxidants, nucleophiles, hydroxide ions, catalytic enzymes, organophosphorous acid anhydrolase, o-iodosobenzoate, iodoxybenzoate, perborate, peracetic acid, m-chloroperoxybenzoic acid, magnesium monoperoxyphthalate, benzoyl peroxide, hydroperoxy carbonate ions, polyoxymetalates, quaternary ammonium complexes, Sandia Foam (Sandia National Laboratories), EasyDECON™ 200 Decontamination Solution, Modec's Decon Formula (Modec, Inc.) or a mixture of two or more thereof.

The humectant may comprise polyacrylic acid, polyacrylic acid salt, an acrylic acid copolymer, a polyacrylic acid salt copolymer, or a mixture of two or more thereof.

The concentration of each of the foregoing additives in the polymer composition (prior to drying or dehydrating) may be up to about 25% by weight, and in one embodiment up to about 10% by weight, and in one embodiment up to about 5% by weight, and in one embodiment up to about 2% by weight, and in one embodiment up to about 1% by weight.

The polymer composition may have a broad range of viscosities and rheological properties which may allow the polymer composition to diffuse into a substrate (i.e., clean or contaminated substrate) for a relatively deep cleaning, allow for a variety of application methods including application via brush, roller or spray equipment, and to allow for a thick enough wet film on non-horizontal surfaces to result in a dry film with sufficient strength to allow for removal by peeling or stripping the film. The surfactant may be used to control or enhance these rheological properties. The Brookfield Viscosity of the polymer composition (prior to drying or dehydrating) may be in the range from about 100 to about 500,000 centipoise, and in one embodiment in the range from about 200 to about 200,000 centipoise measured at the rpm and spindle appropriate for the sample in the range of 0.3-60 rpm and spindles 1-4 at 25° C. The polymer composition may have a sufficient viscosity to permit it to form a wet film on a horizontal and/or a non-horizontal substrate that upon drying or dehydrating forms a solid matrix or film which may be subsequently stripped off the substrate or washed off the substrate.

The polymer composition may be applied to the microorganism and/or infectious agent and allowed to dry. In addition to reducing or eliminating the reproductivity, metabolism, growth and/or pathogenicity of the microorganism and/or infectious agent, the polymer composition upon drying may form a solid matrix that sequesters the microorganism and/or infectious agent.

The microorganism and/or infectious agent may be positioned on a substrate, and the inventive method may comprise applying the polymer composition to the substrate in contact with the microorganism and/or infectious agent, drying the polymer composition to form a film, and removing the film from the substrate. The film may be peeled off the substrate. The film may be removed by applying a composition comprising water (e.g., a cleaning solution comprising soap or detergent and water) to the film then removing the film from the substrate by conventional techniques such as washing or scrubbing.

The polymer composition may be applied to the substrate using conventional coating techniques, for example, brushing, rolling, spraying, spreading, dipping, smearing, and the like. The substrate may comprise a contaminated substrate wherein the film is applied to the contaminated substrate and the contaminant material is taken up by the film. Alternatively, the film may be applied to a clean substrate which is subjected to subsequent contamination wherein the contaminant material is deposited on or in the film and subsequently removed with the film. After application of the polymer composition to the substrate, the polymer composition may be dehydrated or dried to form the film. Dehydration or drying may be enhanced using fans, dehumidifiers, a heat source, or a combination thereof. The contaminant material may be killed or rendered harmless. The contaminant material may be taken up, sorbed and/or complexed by or with the polymer composition or components of the polymer composition. The contaminant material may be adhered to the surface of the film. The film combined with the contaminant material may be separated from the substrate leaving a non-contaminated surface or a surface with a reduced level of contamination. For example, the film may be stripped or peeled from the substrate. The film may be washed off the substrate using a composition comprising water, for example, a cleaning solution comprising water and soap or detergent.

The film may not require removal from the substrate in order to reduce or eliminate the reproductively, metabolism and/or growth of the microorganism and/or infectious agent. The polymer composition may be applied to a substrate and when the polymer composition is dried or dehydrated, resulting in the formation of a film, it may encapsulate, entrap, solublize or emulsify the microorganism and/or infectious agent as well as reduce or eliminate the ability of the microorganism and/or infectious agent to reproduce, metabolize and/or grow.

The dried or dehydrated film may have a concentration of water in the range up to about 25% by weight, and in one embodiment in the range from about 1 to about 15% by weight. When the polymer composition is dehydrated, it may be referred to as a hydrogel. The film may be a strippable or peelable film. The film may have a thickness and tensile strength sufficient to allow for it to be stripped or peeled from a substrate. The film thickness may be in the range up to about 50 mils, and in one embodiment from about 0.01 to about 50 mils, and in one embodiment from about 0.01 to about 25 mils, and in one embodiment from about 0.05 to about 5 mils. The film may be removed from a substrate using conventional washing and scrubbing techniques.

An advantage of the polymer composition is that it may be applied wet to a substrate and then dried or dehydrated to form a solid matrix such as a film. In one embodiment, the formation of the solid matrix does not involve a cross-linking reaction. Thus, the use of a two-component system involving the use of a cross-linking agent may be avoided. This also provides the advantage of being able to rehydrate the polymer film and subject it to analysis as discussed below.

The polymer composition may be delivered in a rehydratable form that may not require a commercial process to rehydrate. Examples may include a powder that can be rehydrated for single use applications. Water may be added with minimal or no agitation. Sodium or potassium neutralized poly(meth)acrylic acids may be useful for direct rehydration for gels or solutions that can be prepared from a dry powder before use.

The polymer composition, in at least one embodiment, may exhibit about 100 times lower toxicity to human HeLa cells in culture than chlorohexidine gluconate (a commonly used bacteriostatic mouth wash).

The polymer composition may be applied to the substrate using a laminate structure. The laminate structure may comprise a layer of the film overlying part or all of one side of a release liner. Alternatively, the film layer may be positioned between two release liners. The film layer may be formed by coating one side of the release liner with the polymer composition using conventional techniques (e.g., brushing, roller coating, spraying, and the like) and then dehydrating or drying the polymer composition to form the film layer. If the laminate structure comprises a second release liner, the second release liner may then be placed over the film layer on the side opposite the first release liner. The film layer may have a thickness in the range from about 1 to about 500 mils, and in one embodiment from about 5 to about 100 mils. The release liner(s) may comprise a backing liner with a release coating layer applied to the backing liner. The release coating layer contacts the film layer and is provided to facilitate removal of the release liner from the film layer. The backing liner may be made of paper, cloth, polymer film, or a combination thereof. The release coating may comprise any release coating known in the art. These may include silicone release coatings such as polyorganosiloxanes including polydimethylsiloxanes. When the laminate structure comprises a release liner on one side of the film layer, the laminate structure may be provided in roll form. The film layer may be applied to a substrate by contacting the substrate with the film layer, and then removing the release liner from the film layer. The film layer may be sufficiently tacky to adhere to the substrate. When the laminate structure comprises a release liner on both sides of the film layer, the laminate structure may be provided in the form of flat sheets. The film layer may be applied to a substrate by peeling off one of the release liners from the laminate structure, contacting the substrate with the film layer, positioning the film layer on the substrate, and then removing the other release liner from the film layer.

The substrates that may be treated with the inventive method may include human skin and wounds, as well as cloth, paper, wood, metal, glass, concrete, painted surfaces, plastic surfaces, and the like. The substrates may include seeds that require surface sterilization or disinfection. The substrate may comprise a porous, permeable or non-porous material. The substrate may comprise horizontally aligned non-porous substrates such as floors, counter tops, table tops, exercise medical equipment, gurneys, heart stress test room surfaces, toilet seats, as well as complex three dimensional structures such as faucets, tools and other types of equipment or infrastructure and the like. The substrate may comprise non-horizontally aligned surfaces such as walls, doors, windows, and the like. The substrates may include tile, Formica, porcelain, chrome, stainless steel, glass, sealed grout, unsealed grout, rubber, leather, plastic, painted surfaces, concrete, wood, reactors, storage vessels, and the like. The substrates may include surgical equipment made of metal, glass, plastic, and the like, as well as instrumentation. The inventive method may be used to decontaminate buildings, medical facilities, articles of manufacture, buildings and infrastructure intended for demolition, military assets, airplanes, as well as the interiors and exteriors of military or civilian ships.

The inventive method may be used to sterilize, decontaminate or disinfect biological laboratories and biological warfare research facilities from contamination ranging from ordinary wide spread microorganisms and/or infectious agents, such as common bacterial and fungal contamination, to the more dangerous multi-drug resistant pathogens, as well as the extremely hazardous materials, such as anthrax, HIV and Ebola viruses.

The film (wet or dry) may be separated (i.e., wiped, washed or peeled) from the substrate and dispersed or dissolved in a liquid such as water and then analyzed for the presence of microorganisms and/or infectious agents. This may involve rehydrating the film. The peeled or separated film may be subjected to polymerase chain reaction (PCR) analysis, and subsequent nucleotide sequence analysis and/or amino acid sequence analysis. The DNA may be extracted and subjected to forensic analysis via PCR amplification with ribosomal DNA primers, and the product thereof may then be subjected to restriction fragment length polymorphism (RFLP), DNA cloning and/or DNA sequencing. This may be used to identify the particular microorganism and/or infectious agent that was killed or inactivated by and contained within the film.

The microorganism and/or infectious agent may be dispersed in a liquid medium such as water, and the process may comprise adding the polymer composition to the liquid medium. The polymer composition may be added at a sufficient concentration and for an effective period of time to reduce or eliminate the reproductivity, metabolism, growth and/or pathogenicity of the microorganism and/or infectious agent.

The killing or inhibiting affect of the polymer composition may be improved by drying or dehydrating the polymer composition while in contact with the microorganisms and/or infectious agents. Thus, in one embodiment the microorganisms and/or infectious agents contacted by the polymer composition may have their reproductivity, metabolism, growth and/or pathogenicity reduced or eliminated by, during or after the drying or dehydrating process.

The polymer composition may be applied to a substrate to form a film and the microorganism and/or infectious agent may subsequently contact the polymer composition. The polymer composition may be wet or dry when contacted by the microorganism and/or infectious agent. The film and the microorganism and/or infectious agent may then be removed from the substrate. The film and the microorganism and/or infectious agent may be removed by peeling the film off the substrate. The film and the microorganism and/or infectious agent may be removed by applying a composition comprising water (e.g., a cleaning solution comprising soap or detergent and water) to the film and the microorganism and/or infectious agent, and then removing the film and the microorganism and/or infectious agent from the substrate using conventional techniques such as washing or scrubbing.

The killing or inhibiting affect of the polymer composition may leach out into areas near but not in direct contact with the polymer composition. Thus, in one embodiment, microorganisms and/or infectious agents near the microorganisms and/or infectious agents contacted by the polymer composition may have their reproductivity, metabolism, growth and/or pathogenicity reduced or eliminated.

The inventive method may involve contacting or stripping the substrate with the polymer and drying the polymer composition to form a polymer film, trapping the microorganism and/or infectious agent within the dried polymer film, and separating the dried polymer film from the substrate. The microorganism and/or infectious agent may be separated from the substrate with the film. The surface left behind may be devoid of the microorganisms and/or infectious agents and left sterile. The separated polymer film may be subjected to PCR/RFLP analysis for identification of the microorganism and/or infectious agent. The polymer film may be re-hydrated, and the polymer film and now-inactivated microorganism and/or infectious agent may be removed using traditional methods, for example, soap and water.

The following Examples 1-6 provide examples of preparation of the polymer composition that may be used with the inventive method. In these examples, as well as throughout the text, unless otherwise indicated, all parts and percentages are by weight.

### EXAMPLE 1

A jacketed one-liter reactor equipped with a thermocouple, condenser and stir motor is charged with 677.2 grams of distilled water, 8.0 grams of diethylenetriaminepentaacetic acid (DTPA), 8.0 grams of sodium dodecyl sulfate (SDS), 7.9 grams of 10 N sodium hydroxide, 4.0 grams of Byk-028 (product of BYK Chemie identified as a mixture of foam destroying polysiloxanes and hydrophobic solids in polyglycol). The resulting aqueous composition is agitated until the salts are dissolved followed by the addition of 123.0 grams of Celvol 523. The mixture is heated to 85° C. and held for 30 minutes, then cooled to 70° C. The mixture is then cooled to 45° C. while adding 49.0 grams of ethanol to the mixture. 12.0 grams of BYK-420 (a product of Chemie identified as a solution of modified urea described as being useful for providing thixotropic flow behavior and anti-sagging properties) are added drop wise to the mixture with stirring over a period of 1 hour. 4.0 grams of BYK-345 (a product of Chemie identified as polyether modified siloxane described as being useful as a wetting agent), 1.0 grams of Dowicil 75, 2.0 grams of blue food coloring, and 83.0 grams of distilled water are added. The resulting polymer composition has pH of 7.22. This polymer composition may be referred to as an aqueous polymer composition.

### EXAMPLE 2

A jacketed one-liter reactor equipped with a thermocouple, condenser and stir motor is charged with 677.2 grams of distilled water, 8.0 grams of DTPA, 8.0 grams of SDS, 7.9 grams of 10 N sodium hydroxide, 4.0 grams of Byk-028, and 4.0 grams of Byk-080A (product of BYK Chemie identified as hydrophobic solids and polysiloxanes). The resulting aqueous composition is agitated until the salts are dissolved followed by the addition of 123.0 grams of Celvol 523. The mixture is heated to 85° C. and held for 30 minutes, then cooled to 70° C. The mixture is then cooled to 45° C. while adding 49.0 grams of ethanol to the mixture. 12.0 grams of BYK-420 are added drop wise to the mixture with stirring over a period of 1 hour. 4.0 grams of BYK-345, 1.0 grams of Dowicil 75, 2.0 grams of blue food coloring, and 83.0 grams of distilled water are added. The resulting polymer composition has pH of 6.81. This polymer composition may be referred to as an aqueous polymer composition.

### EXAMPLE 3

A jacketed one-liter reactor equipped with a thermocouple, condenser and stir motor is charged with 1708.3 grams of distilled water, 8.5 grams of DTPA, 8.5 grams of SDS, 8.5 grams of 10 N sodium hydroxide, 4.2 grams of Byk-028 and 4.2 grams of Byk-080A. The resulting aqueous composition is agitated until the salts are dissolved followed by the addition of 125.0 grams of Celvol 523. The mixture is heated to 85° C. and held for 30 minutes, then cooled to 70° C. The mixture is then cooled to 45° C. while adding 50.0 grams of ethanol to the mixture. 12.5 grams of BYK-420 are added drop wise to the mixture with stirring over a period of 1 hour. 4.2 grams of BYK-345 1.3 grams of Dowicil 75, 2.1 grams of blue food coloring, and 83.3 grams of distilled water are added. 1.3 grams of 10 N NaOH are added. The resulting polymer composition has pH of 7.96. This polymer composition may be referred to as an aqueous polymer composition.

### EXAMPLE 4

A jacketed one-liter reactor equipped with a thermocouple, condenser and stir motor is charged with 645.5 grams of distilled water, 8.0 grams of DTPA, 28.5 grams of Stanfax 1025 (a product of Para Chem, Chemidex LLC, identified as sodium lauryl sulfate), 4.0 grams of 46% sodium hydroxide, 4.0 grams of Byk-028, and 4.0 grams of Byk-080A. The resulting aqueous composition is agitated until the salts are dissolved followed by the addition of 123.0 grams of Celvol 523. The mixture is heated to 85° C. and held for 30 minutes, then cooled to 70° C. The mixture is cooled to 45° C. while adding 46.5 grams of ethanol SDA 3C 190 PF (denatured alcohol) to the mixture. 12.5 grams of BYK-420 are added drop wise to the mixture with stirring over a period of 1 hour. 4.0 grams of BYK-345, 0.05 gram of Spectrazurine Blue FGND-C LIQ (supplied by Spectra Color Corp.), and 39.0 grams of distilled water are added. A premix of 1.5 grams of Dowicil 75 and 63.0 grams of distilled water are added. 200.0 grams of the resulting polymer composition are added to 800.0 grams of distilled water to provide a polymer composition that is diluted to 20% by weight. The resulting polymer composition has pH of 6.13. The diluted polymer composition may be referred to as being diluted to 20% by weight.

### EXAMPLE 5

A jacketed one-liter reactor equipped with a thermocouple, condenser and stir motor is charged with 645.5 grams of distilled water, 8.0 grams of DTPA, 28.5 grams of (Stanfax 1025), 4.0 grams of 46% sodium hydroxide, 4.0 grams of Byk-028, and 4.0 grams of Byk-080A. The resulting aqueous composition is agitated until the salts are dissolved followed by the addition of 123.0 grams of Celvol 523. The mixture is heated to 85° C. and held for 30 minutes, then cooled to 70° C. The mixture is cooled to 45° C. while adding 46.5 grams of ethanol SDA 3C 190 PF to the mixture. 12.5 grams of BYK-420 are added drop wise to the mixture with stirring over a period of 1 hour. 4.0 grams of BYK-345, 0.05 gram of Spectrazurine Blue FGND-C LIQ, and 39.0 grams of distilled water are added. A premix of 1.5 grams of Dowicil 75 and 63.0 grams of distilled water are added. 20.0 grams of the resulting polymer composition are added to 980 grams of distilled water to provide a polymer composition that is diluted to 2% by weight. The resulting polymer composition has pH of 5.89 This polymer composition may be referred to as being diluted to 2% by weight.

### EXAMPLE 6

A jacketed one-liter reactor equipped with a thermocouple, condenser and stir motor is charged with 645.5 grams of distilled water, 8.0 grams of DTPA, 28.5 grams of Stanfax 1025, 4.0 grams of 46% sodium hydroxide, 4.0 grams of Byk-028, and 4.0 grams of Byk-080A. The resulting aqueous composition is agitated until the salts are dissolved followed by the addition of 123.0 grams of Celvol 523. The mixture is heated to 85° C. and held for 30 minutes, then cooled to 70° C. The mixture is cooled to 45° C. while adding 46.5 grams of ethanol SDA 3C 190 PF to the mixture. 12.5 grams of BYK-420 are added drop wise to the mixture with stirring over a period of 1 hour. 4.0 grams of BYK-345, 0.05 gram of Spectrazurine Blue FGND-C LIQ, and 39.0 grams of distilled water are added. A premix of 1.5 grams of Dowicil 75 and 63.0 grams of distilled water are added. 2.0 grams of the resulting polymer composition are added to 998 grams of distilled water to provide a polymer composition that is diluted to 0.2% by weight. The resulting polymer composition has pH of 4.87.

### EXAMPLE 7

The polymer composition from Example 3 is diluted with sterile nanopure water to prepare the following diluted polymer compositions: 50%, 25%, 10%, 0%. 250 μl of the diluted polymer composition are mixed with or covered on 10 μl solutions of various bacteria (˜10⁶). Samples of the resulting mixtures are covered and sealed for 12 or 20 hours at room temperature. Additional samples of the resulting mixtures are left open for 12 or 20 hours at room temperature in a sterile hood. 1 ml of Luria Broth (LB) or Nutrient Broth (NB) is added to each sample. The samples are incubated at 37° C. without shaking for 24 or 37 hours. Three 200 μl portions of each sample are transferred to a 96-well plate. Absorbance is measured at 595 nm using a 96-well plate reader.

1 ml of LB or NB is added to the remaining mixture of polymer composition and bacteria solution (˜400 μl). The mixture is incubated at 37° C. for 27 or 23 hours (51 or 60 hours total incubation time). Three 200 μl portions of each sample are transferred to a 96-well plate. Absorbance is measured at 595 nm using the 96-well plate reader.

Samples of each of E. coli, S. epidermidis, S. aureus (MRSA), and B. cepacia are tested. Each sample is inhibited, whether the polymer composition is rubbed in and dried or not dried, only covered and dried or not dried, or sealed and not dried. Twelve-hour exposure to ≧25% concentration of the polymer composition from Example 3 is sufficient to completely inhibit the growth of each of the species tested.

### EXAMPLE 8

The minimum inhibitory concentration (MIC) for the bacteria species identified in the table below is determined using the polymer composition from Example 3. MIC is the lowest concentration of an antibiotic agent that inhibits spectrophotometrically measurable bacterial growth. The polymer composition from Example 3 is diluted with sterile nanopure water to prepare a 25% polymer composition. The following diluted polymer compositions are obtained by twofold series dilution with broth as diluent: 12.5%, 6.25%, 3.1%, 1.6%, 0.8%, 0.4%, 0.2%, and 0%. With each of these, the polymer composition from Example 3 is diluted to provide for the desired diluted polymer composition. For example, the polymer composition diluted to 6.25% contains 6.25% of the product from Example 3. In this example, as well as throughout the text, unless otherwise indicated, all concentrations are by volume. Inoculum suspensions for bacteria identified in the table are obtained by inoculating 20 μl solutions of the bacteria (˜2×10⁶) overnight culture to 1 ml fresh broth medium. Test samples are prepared by mixing 100 μl of bacterium inoculum suspensions with 100 μl of the diluted polymer compositions. The results are as follows:

| Diluted | Control: | | | S. | | | E. | | | | |
|---|---|---|---|---|---|---|---|---|---|---|---|
| Polymer | No | | S. | aureus | | B. | faecalis | Strep | A. | E. coli | P. |
| Composition | bacteria | E. coli | epidermidis | (MRSA) | B. cepacia | subtilis | (VRE) | A | baumannii | O157:H7 | aeruginosa |
| 6.25% | No | No | No | No | No | No | No | No | No | No | No |
| 3.1% | No | No | No | No | No | No | No | No | No | Yes | No |
| 1.6% | No | Yes | No | Yes | No | No | No | No | No | Yes | Yes |
| 0.8% | No | Yes | No | Yes | Yes | No | Yes | No | No | Yes | Yes |
| 0.4% | No | Yes | No | Yes | Yes | No | Yes | No | Yes | Yes | Yes |
| 0.2% | No | Yes | Yes | Yes | Yes | No | Yes | No | Yes | Yes | Yes |
| 0.1% | No | Yes | Yes | Yes | Yes | Yes | Yes | Yes | Yes | Yes | Yes |
| 0% | No | Yes | Yes | Yes | Yes | Yes | Yes | Yes | Yes | Yes | Yes |

NOTE:
On the above table, “Yes” represents growth; “No” represents no growth.

The foregoing results from Examples 8 indicate that the MIC for the polymer composition from Example 3 is dependent on the species of bacteria tested. These are as follows:

| | | | | | | | | E. | | |
|---|---|---|---|---|---|---|---|---|---|---|
| | | S. | S. aureus | | E. coli | P. | B. | faecalis | Strep | A. |
| Species | E. coli | epidermidis | (MRSA) | B. cepacia | (O157:H7) | aeruginosa | subtilis | (VRE) | A | baumannii |
| MIC | 3.1% | 0.4% | 3.1% | 1.6% | 6.2% | 3.1% | 0.2% | 1.6% | 0.2% | 0.8% |

### EXAMPLE 9

The MIC against S. epidermidis and P. aeruginosa to develop a biofilm is determined. The polymer composition from Example 3 is diluted with sterile nanopure water to prepare a 50% polymer composition. The following diluted polymer compositions are obtained by twofold series dilution with broth as diluent: 25%, 12.5%, 6.25%, 3.1%, 1.6%, 0.8%, 0.4%, 0.2%, and 0%. Bacteria inoculum suspensions are obtained by inoculating 20 μl solutions of the bacteria (˜2×10⁶) overnight culture to 1 ml fresh broth medium. Test samples are prepared by mixing 500 μl of bacterium inoculum suspensions with 500 μl of the diluted polymer compositions. The samples are incubated stationary at 37° C. for 24 hours. The results are indicated below.

| Diluted Polymer | Control: | | |
|---|---|---|---|
| Composition | No bacteria | S. epidermidis | P. aeruginosa |
| 12.5% | No | No | Yes |
| 6.25% | No | Yes | Yes |
| 3.1% | No | Yes | Yes |
| 1.6% | No | Yes | Yes |
| 0.8% | No | Yes | Yes |
| 0.4% | No | Yes | Yes |
| 0.2% | No | Yes | Yes |
| 0.1% | No | Yes | Yes |
| 0% | No | Yes | Yes |

NOTE:
On the above table, “Yes” represents growth; “No” represents no growth.

### EXAMPLE 10

The polymer composition from Example 3 is used to kill or inhibit a pre-formed biofilm of individual bacterial species. The polymer composition from Example 3 is diluted with sterile nanopure water to prepare the following diluted polymer compositions: 50%, 25%, 10%, 0%. A preformed biofilm is prepared by inoculating 1 ml of a growth medium in wells with 10 μl of an overnight bacterial growth (˜10⁶) and incubating the mixture at 37° C. for 24 hours. The biofilm forms on the bottom and the sides of the wells. The growth medium is removed. 0.2 ml or 0.3 ml of diluted polymer compositions are pipetted into the wells containing S. epidermidis biofilms or P. aeruginosa biofilms, and maintained at room temperature in a sterile hood until dry. This results in the formation of polymer films in each of the wells. Half of the films are peeled off and transferred to sterile empty wells, with the other half left in situ. 1 ml of fresh growth medium is added to each well and incubated at 37° C. for several or 24 hours. 20 μl from each well are pipetted into new wells with 1 ml of broth and incubated at 37° C. for 48 hours. If pre-formed biofilms are not completely killed by diluted polymer compositions, biofilms are formed in the wells. The biofilms are stained with crystal violet. The wells are visually inspected for biofilm development, and pictures are taken using a Kodak Image Analyzer. The results are indicated below.

| Diluted Polymer | S. epidermidis | | | P. aeruginosa | | |
|---|---|---|---|---|---|---|
| Composition | Bact/Polymer | Surface | Film | Bact/Polymer | Surface | Film |
| 50% | No | No (7/8) | No | No | No | No |
| 25% | No | No (7/8) | No | No | No (1/2) | No |
| 10% | No (7/8) | No (5/8) | No (7/8) | Yes | Yes | No |
| 0% | Yes | Yes | Yes | Yes | Yes | Yes |

In the above table, “Yes” represents biofilm growth in all samples, “No” represents no growth in all samples, and “No (N₁/N₂)” represents N₁ out of N₂ sample(s) has/have no growth. The term Bact/Polymer refers to a mixture of bacteria and diluted polymer composition. The term “Surface” refers to the well surface after dry gel is peeled off. The term “Film” refers to the peeled off film. 0.3 ml P. aeruginosa is used instead of 0.2 ml because its biofilm tends to flow on the surface and attach to the air-liquid interface. The MIC of the polymer composition to inhibit biofilm formation, and the capability of a series concentration of polymer composition to kill pre-formed biofilm upon drying, i.e., minimum tested concentration to completely kill biofilm (MTC), are shown in the table below.

| | S. epidermidis | P. aeruginosa |
|---|---|---|
| MIC for polymer composition to inhibit | 12.5% | >12.5% |
| biofilm formation | | |
| Minimum tested concentration to kill | 10% | 25% |
| preformed biofilm (bact/polymer) | | |
| Minimum tested concentration to kill | 25% | 50% |
| preformed biofilm (surface) | | |
| Minimum tested concentration to kill | 10% | 10% |
| preformed biofilm (film) | | |

### EXAMPLE 11

The capability of the polymer composition from Example 3 to kill individual bacterial species or spores upon drying is determined. The polymer composition from Example 3 is diluted with sterile nanopure water to prepare the following diluted polymer compositions: 50%, 25%, 10%, 0%. 10 μl samples of bacteria (˜10⁶) overnight culture solutions are covered with 0.2 ml of each of the diluted polymer compositions and left at room temperature in a sterile hood for 12-24 hours. This results in the formation of polymer films. Half of the films are peeled off and transferred to empty sterile wells, with the other half left in situ. 1 ml of broth is added to each well. After 1-2 hours incubation at 37° C., 20 μl of mixtures are pipetted from each well into a new well containing 1 ml broth. All the samples are incubated at 37° C. for ˜48 hours. Three 200 μl aliquots of each sample are transferred to a 96-well plate. Absorbance is measured at 595 nm using the 96-well plate reader. The results are as follows:

| | Diluted | | | |
|---|---|---|---|---|
| | Polymer | | | |
| | Composi- | | | |
| Bacteria | tion (%) | Bact/Polymer | Surface | Film |
| S. pyogenes | 10 | No (1/2) | No | No |
| Group A | 25 | No | No (1/2) | No |
| | 50 | No | No | No |
| S. epidermidis | 10 | No | No | No |
| | 25 | No | No | No |
| | 50 | No | No | No |
| A. baumannii | 10 | No | No | No |
| | 25 | No | No | No |
| | 50 | No | No | No |
| B. cepacia | 10 | No | No | No |
| | 25 | No | No | No |
| | 50 | No | No | No |
| P. aeruginosa | 10 | No | No | No |
| | 25 | No | No | No |
| | 50 | No | No | No |
| S. aureus | 10 | No | No | No |
| (MRSA) | 25 | No | No | No |
| | 50 | No | No | No |
| E. coli | 10 | No | No | No |
| | 25 | No | No | No |
| | 50 | No | No | No |
| E. coli O157:H7 | 10 | No | No | No (1/2) |
| | 25 | No (1/2) | No (1/2) | No (1/2) |
| | 50 | No | No | No |

In the above tables, “No” represents no growth in all samples, and “No (Ni/N₂)” represents N₁ out of N₂ sample(s) has/have no growth. The term Bact/Polymer refers to a mixture of bacteria and the diluted polymer composition. The term “Surface” refers to the well surface after dry gel is peeled off. The term “Film” refers to the peeled off film in the well.

### EXAMPLE 12

The polymer composition from Example 3 is diluted with sterile nanopure water to prepare the following diluted polymer compositions: 50%, 25%, 10%, 0%. For each diluted polymer composition, 10 μl of a solution containing B. subtilis spores (˜10⁵) are covered with 0.2 ml of the diluted polymer composition and left at room temperature in a sterile hood for 25 hours. Half of the resulting polymer films are peeled off and transferred to empty sterile wells, with the other half kept in situ. 1 ml broth is added to each well and incubated at 37° C. for 24 hours. After 1 hour incubation at 37° C., 20 μl of mixtures are pipetted from each well into a new well containing 1 ml broth. All the samples are incubated at 37° C. for ˜48 hours. Three 200 μl aliquots of each sample are transferred to a 96-well plate. Absorbance is measured at 595 nm using the 96-well plate reader. The results are as follows:

| Diluted Polymer | B. subtilis spores | | |
|---|---|---|---|
| Composition | Bact/Polymer | Surface | Film |
| 50% | No | Yes | No |
| 25% | Yes (1/2) | No | Yes |
| 10% | Yes | Yes (1/2) | Yes |
| 0% | Yes | Yes | Yes |

In the above table, “Yes” represents growth in all samples, “No” represents no growth in all samples, and “No (N₁/N₂)” represents N₁ out of N₂ sample(s) has/have no growth. The term “Bact/Polymer” refers to a mixture of bacteria and the indicated diluted polymer composition. The term “Surface” refers to the well surface after dry gel is peeled off. The term “Film” refers to the peeled off film in the well.

The results from Examples 11 and 12 indicate that the minimum tested concentration (MTC) to completely kill planktonic bacteria and spores for the species tested, upon drying, is as follows:

| | | | | | S. | | | | |
|---|---|---|---|---|---|---|---|---|---|
| | | E. coli | | | aureus | | | | B. subtilis |
| | E. coli | O157:H7 | P. aeruginosa | S. epidermidis | (MRSA) | B. cepacia | A. baumannii | Strep A | spores |
| MTC - | 10% | 50% | 10% | 10% | 10% | 10% | 10% | 10% | 50% |
| bact/polymer | | | | | | | | | |
| MTC - | 10% | 50% | 10% | 10% | 10% | 10% | 10% | 50% | ≧50% |
| surface | | | | | | | | | |
| MTC - | 10% | 50% | 10% | 10% | 10% | 10% | 10% | 10% | 50% |
| film | | | | | | | | | |

### EXAMPLE 13

The minimum bactericidal concentration (MBC) of individual bacterial species is determined. MBC is the lowest concentration of a material that fully kills bacteria. The polymer composition from Example 3 is diluted with sterile nanopure water to prepare a 25% or 50% polymer composition. The following diluted polymer compositions are obtained by twofold series dilution with broth as diluent: 25%, 12.5%, 6.25%, 3.1%, 1.6%, 0.8%, 0.4%, 0.2%, 0.1%, and 0%. Bacterial inoculum suspensions are obtained by inoculating 20 μl solutions of the bacteria (˜2×10⁶) overnight culture to 1 ml fresh broth medium. Test samples are prepared by mixing 100 μl of bacterial inoculum suspensions with 100 μl of the diluted polymer compositions. The samples are incubated stationary at 37° C. for 24 hours. For samples with no visible bacterial growth, polymer and bacteria mixtures are plated on agar plates. Bacteria growth is checked after 24 hours and 48 hours incubation at 37° C. The results are indicated in the following table.

| Diluted | | | | | |
|---|---|---|---|---|---|
| Polymer | S. aureus | | E. faecalis | E. coli | |
| Composition | (MRSA) | B. subtilis | (VRE) | (O157:H7) | P. aeruginosa |
| 12.5% | No (8/9) | — | — | Yes (9/9) | No (9/9) |
| 6.25% | Yes (9/9) | No (6/6) | Yes (6/6) | Yes (9/9) | Yes (9/9) |
| 3.1% | Yes (9/9) | No (6/6) | Yes (6/6) | Yes (7/9) | Yes (9/9) |
| 1.6% | — | No (6/6) | Yes (6/6) | — | — |
| 0.8% | — | No (6/6) | — | — | — |
| 0.4% | — | No (5/6) | — | — | — |
| 0.2% | — | Yes (3/3) | — | — | — |

Note:
“Yes (N1/N2)/No (N1/N2)” on the above table represents N1 out of N2 samples have/do not have bacterial growth on agar plates; “—” represents not determined.

The foregoing indicates that the MBCs for the polymer composition from Example 3 are as follows:

| | | | | E. coli | |
|---|---|---|---|---|---|
| Species | S. aureus | B. subtilis | E. faecalis | (O157:H7) | P. aeruginosa |
| MBC | >=12.5% | 0.4%-0.8% | >6.25% | >12.5% | 12.5% |

### EXAMPLE 14

The MBC for S. aureus (MRSA) is determined. The polymer composition from Example 1 is diluted with sterile nanopure water to prepare the following diluted polymer compositions: 10%, 5%, 1%, 0.5%, 0.1%, and 0%. Test samples are prepared by mixing 1 ml of growth media with 0.2 ml of each of the diluted polymer compositions. These test samples are inoculated with 10 μl of bacteria (˜10⁶) for 24 hours. 10 μl of media are streaked on an LB plate and incubated at 37° C. for 24 hours. Growth is visibly determined. The results are as follows:

| Diluted Polymer Composition | S. aureus (MRSA) |
|---|---|
| 10% | No |
| 5% | No |
| 1% | No |
| 0.5% | Yes |
| 0.1% | Yes |
| 0% | Yes |

### EXAMPLE 15

The residual kill potential of a peeled off film of the polymer composition from Example 3 is determined for certain species of bacteria. The polymer composition from Example 3 is diluted with sterile nanopure water to prepare is used along with the following diluted polymer compositions: 100%, 50%, 25%, 10%, and 0%. (The 100% sample is not diluted.) 0.2 ml samples of each of the polymer compositions are placed in wells. The polymer compositions are maintained in the wells at room temperature under a sterile hood for 24 hours. The polymer compositions dry to form film layers. The film layers are peeled off and discarded. 1 ml of broth inoculated with B. subtilis spores (˜10⁴) or E. faecalis (˜10⁶, or 10⁵) are transferred to wells and incubated at 37° C. for 48 hours. Three 200 μl samples from each well are transferred to a 96-well plate. Absorbance is measured at 595 nm using a 96-well plate reader. The results are as follows:

| | | B. subtilis | E. faecalis | E. faecalis |
|---|---|---|---|---|
| Polymer | Control: | spores | (VRE) | (VRE) |
| Composition | No Gel | (10⁴) | (10⁶)/ml | (10⁵)/ml |
| 100% | | No | Yes | — |
| 50% | | No | Yes | Yes |
| 25% | | Yes | Yes | Yes |
| 10% | | Yes | Yes | — |
| 0% | Yes | Yes | Yes | Yes |

NOTE:
On the above table, “Yes” represents growth; “No” represents no growth; “—” represents not determined.

### EXAMPLE 16

The killing efficacy of the polymer composition from Example 3 at the species-specific MBC as a function of exposure time is determined.

˜10⁷ S. aureus (MRSA), P. aeruginosa, and E. coli O157:H7 are incubated stationary in the absence or presence of the composition for Example 3 diluted to 12.5% for 24 hours at 37° C. in an incubator. Starting from time 0, aliquots of 0.1 ml samples are removed for colony count plating every 2 hours for 12 hours, and at 24 hours. Colony numbers on agar plates are counted after 22-26 hours incubation at 37° C., and checked again after 36-48 hours. The bacteria killed (log reduction/percentage killed) after 12 hours and 24 hours by the composition from Example 3 diluted to 12.5% are as follows:

| | S. aureus (MRSA) | P. aeruginosa | E. coli O157:H7 |
|---|---|---|---|
| 12 h | 4.32/99.995 | 2.67/99.8 | 0.56/72.2 |
| 24 h | 7.28/100 | 6.64/100 | 0.88/86.8 |

### EXAMPLE 17

The MIC of individual fungal species in solution is determined. Yeast growth medium (YM) is inoculated with 1:20 dilution of an overnight growth of C. albicans, aliquoted in duplicates into 1 ml wells in the presence of the following diluted polymer compositions from Example 1: 10%, 5%, 2.5%, 1.25% and 0%, and incubated for 24 hours at 37° C. Under these conditions, C. albicans grows predominantly as a biofilm on the bottom of the well. [4,4-dimethylthiazol-2-yl]-2,5-diphenyltetrazolium bromide (MTT) reagent is added for 2 hours, media is removed and the cells are solubilized in 100% dimethylsulfoxide (DMSO). 200 μl samples are aliquoted into a 96-well plate and read on a spectrophotometric plate reader. Absorbance is measured at 495 nm. The MIC of Example 1 in solution for C. albicans is determined to be 2.5%.

### EXAMPLE 18

The ability of Example 1 to kill individual fungal species in solution upon polymer drying is determined. 10 μl of overnight C. albicans growth is placed on the bottom of a 1 ml well and covered with 50 μl of undiluted polymer composition from Example 1 and allowed to dry overnight (in duplicates). The dried peel is removed and placed into a new well. 1 ml of yeast growth medium is added to the left-behind well and the peel-containing well. The wells are incubated for 24 hours to allow any residual viable yeast to proliferate. Neither set of wells has any growth as assessed by the MTT viability assay. The polymer composition from Example 1, upon drying, kills all the C. albicans organisms trapped within the peel and leaves behind a sterile surface.

### EXAMPLE 19

The residual kill potential of a peeled film formed from the polymer composition of Example 1 is determined for fungus. The polymer composition from Example 1 as well as the following dilutions thereof using sterile nanopure water are used: 50%, 25%, 12%, 6%, and 0%. 0.2 ml of each of the polymer compositions are placed in wells and maintained at room temperature in a sterile hood for 24 hours until dry. The resulting films are peeled off and discarded. 2 ml of yeast growth media inoculated with 1:20 overnight culture of C. albicans are added to each polymer-pre-treated well and allowed to incubate for 18 hours. In order to quantify growth, MTT reagent is added to each well and maintained therein for three hours. Cells are solubilized in 100% DMSO. Samples are placed on a spectrophotometric plate reader. Absorbance is measured at 495 nm. The MTT-measured viability of C. albicans is as follows:

| Polymer Composition | C. albicans | |
|---|---|---|
| 100% | 32% | growth |
| 50% | 13% | growth |
| 25% | 0.39% | growth |
| 12% | 42% | growth |
| 6% | 47% | growth |
| 0% | 100% | growth |

### EXAMPLE 20

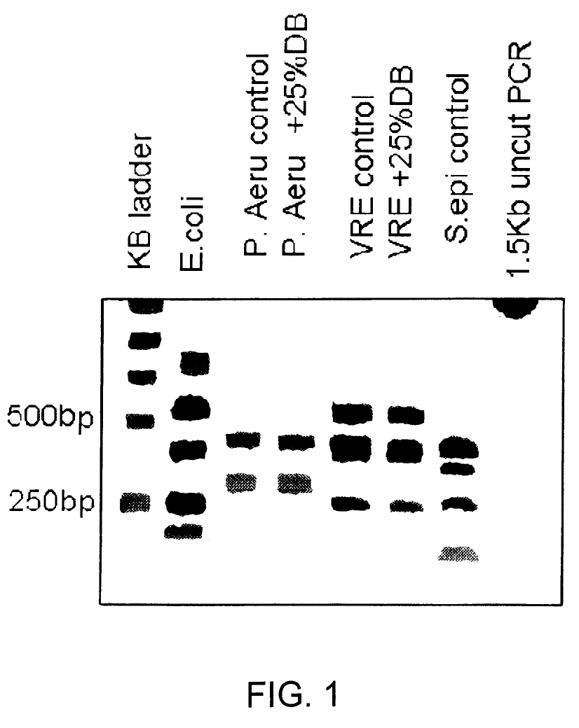

Identity of the polymer-inactivated bacteria is determined as follows. Bacteria (10 μl of ON growth (˜10⁶)) is placed in a well and either covered with the polymer composition from Example 3 or not and then allowed to dry overnight. The peel is either removed and placed into a sterile tube or re-hydrated with water in situ. In either case, enough water is added to obtain ˜25% gel consistency. The fluid is phenol-chloroform extracted. The DNA ethanol is precipitated and then re-suspended in 20 μl of water. 0.5 μl of this sample are used as a template in a PCR reaction which uses the universal rDNA primers. After PCR is complete, 5 μl of the 1.5 Kb product are digested in a 10 μl Hal restriction enzyme digest reaction. The digest is analyzed for the size DNA pattern by 1.5% agarose electrophoresis where the DNA bands are detected by ethidium bromide. The RFLP patterns obtained from the control (untreated) and treated bacterial samples are photographed and compared for identification. Restriction fragment patterns found in the sample inactivated by the polymer are identical to the restriction pattern of the non-inactivated viable bacteria that was left to dry untreated. The restriction fragment patterns are unique for each bacteria and can visually be distinguished from each other. This is shown in FIG. 1.

Results for the polymer composition from Example 3 with respect to treating various bacteria are summarized in the following table.

| | Escherichia | Staphylococcus | Staphylococcus | Staphylococcus | Burkholderia. | Bacillus | Bacillus |
|---|---|---|---|---|---|---|---|
| | coli | epidermidis | epidermidis | aureus | cepacia | subtilis | subtilis |
| Strain | ATCC | ATCC 35984 | ATCC 35984 | ATCC BAA-44 | ATCC 10856 | Grown | spores |
| | 25922 | | Biofilm | (MRSA) | | from | |
| | | | | | | spores | |
| | | | | | | from | |
| | | | | | | GIBCO- | |
| | | | | | | BRL | |
| Bacteria/virus | Bacteria | Bacteria | Bacteria | Bacteria | Bacteria | Bacteria | Bacteria |
| Gram −/+ | Negative | Positive | Positive | Positive | Negative | Positive | Positive |
| O₂ | Aerobic | Aerobic | Aerobic | Aerobic | Aerobic | Aerobic | Aerobic |
| MIC (in | 3.1% | 0.8% | 12.5% | 3.1% | 1.6% | 0.2% | |
| solution) | | | | | | | |
| MBC (in | | | >3.1% | 12.5% | | 0.8% | |
| solution) | | | | | | | |
| MTC (bact + | 10% | 10% | 10% | 10% | 10% | | 50% |
| polymer) | | | | | | | |
| MTC % | 10% | 10% | 10% | 10% | 10% | | ≧50% |
| Polymer | | | | | | | |
| (surface) | | | | | | | |
| MTC Polymer | 10% | 10% | 10% | 10% | 10% | | 50% |
| MTC (residual | | | | | | 50% | |
| surface) | | | | | | | |
| % killed @ | | | | 100% | | | |
| MBC @ 24 hrs | | | | | | | |
| in solution | | | | | | | |

| | | | | | Streptococcus | | |
|---|---|---|---|---|---|---|---|
| | Enterococcus | Escherichia | Pseudomonas | Pseudomonas | pyogenes | Acinetobacter | Candida |
| | faecalis | coli | aeruginosa | aeruginosa | (Strep A) | baumannii | albicans |
| Strain | ATCC 51299 | O157:H7 | ATCC 27853 | ATCC 27853 | Carolina | ATCC 15151 | |
| | (VRE) | ATCC | | Biofilm | Biological | | |
| | | 51657 | | | Supply | | |
| Bacteria/ | Bacteria | Bacteria | Bacteria | Bacteria | Bacteria | Bacteria | Fungus |
| virus | | | | | | | |
| Gram | Positive | Negative | Negative | Negative | Positive | Negative | NA |
| −/+ | | | | | | | |
| O₂ | Aerobic | Aerobic | Aerobic | Aerobic | Aerobic | Aerobic | Aerobic |
| MIC (in | 1.6% | 6.2% | 3.1% | >12.5% | 0.2% | 0.8% | |
| solution) | | | | | | | |
| MBC (in | >6.25% | >12.5% | 12.5% | | | | |
| solution) | | | | | | | |
| MTC (bact + | | 50% | 10% | | 10% | 10% | |
| polymer) | | | | | | | |
| MTC % | | 50% | 10% | | 50% | 10% | |
| Polymer | | | | | | | |
| (surface) | | | | | | | |
| MTC | | 50% | 10% | | 10% | 10% | |
| Polymer | | | | | | | |
| MTC | 100%- not | | | | | | |
| (residual | effective | | | | | | |
| surface) | | | | | | | |
| % killed @ | | | 100% | | | | |
| MBC @ | | | | | | | |
| 24 hrs in | | | | | | | |
| solution | | | | | | | |

### EXAMPLE 21

The MIC against S. epidermidis is determined using a new polymer composition modified from Example 3. In the new polymer composition, same amount of (HDTMA=SDS), or 1/10 of HDTMA (HDTMA= 1/10 of SDS) is used to replace SDS as a surfactant. The modified polymer composition is diluted with sterile nanopure water to prepare a 12.5% polymer composition. The following diluted polymer compositions are obtained by twofold series dilution with broth as diluent: 6.25%, 3.1%, 1.6%, 0.8%, 0.4%, 0.2%, 0.1%, and 0%. Bacteria inoculum suspension is obtained by inoculating 20 μl solutions of the bacteria (˜2×10⁶) overnight culture to 1 ml fresh broth medium. Test samples are prepared by mixing 100 μl of bacterial inoculum suspensions with 100 μl of the diluted polymer compositions. The samples are incubated stationary at 37° C. for 24 hours. The results are indicated below.

| Diluted | | | | Example 3 |
|---|---|---|---|---|
| Polymer | Control: No | HDTMA = | HDTMA = | polymer |
| Composition | bacteria | SDS | 1/10 SDS | composition |
| 3.1% | No | No | No | No |
| 1.6% | No | No | No | No |
| 0.8% | No | No | No | No |
| 0.4% | No | No | No | Yes |
| 0.2% | No | No | No | Yes |
| 0.1% | No | No | No | Yes |
| 0.05% | No | No | Yes | Yes |
| 0% | No | Yes | Yes | Yes |

NOTE:
On the above table, “Yes” represents growth; “No” represents no growth.

The following minimum inhibitory concentrations (MIC) against S. epidermidis are determined.

| | | | Example 3 |
|---|---|---|---|
| | HDTMA = | HDTMA = | polymer |
| | SDS | 1/10 SDS | composition |
| MIC | <=0.05% | 0.1% | 0.8% |

### EXAMPLE 22

The minimum bactericidal concentration (MBC) of individual bacterial species is determined for polymer compositions described in Example 21. The polymer compositions are diluted with sterile nanopure water to prepare 12.5% polymer compositions. The following diluted polymer compositions are obtained by twofold series dilution with broth as diluent: 6.2%, 3.1%, 1.6%, 0.8%, 0.4%, 0.2%, 0.1%, and 0%. Bacterial inoculum suspension is obtained by inoculating 20 μl solutions of the bacteria (−2×10⁶) overnight culture to 1 ml fresh broth medium. Test samples are prepared by mixing 100 μl of bacterial inoculum suspensions with 100 μl of the diluted polymer compositions. The samples are incubated stationary at 37° C. for 24 hours. For samples with no visible bacterial growth, polymer and bacteria mixtures are plated on agar plates. Bacterial growth is checked after 24 hours and 48 hours incubation at 37° C. The results are indicated in the following table.

| | | | Example 3 |
|---|---|---|---|
| Diluted Polymer | HDTMA = | HDTMA = | polymer |
| Composition | SDS | 1/10 SDS | composition |
| 3.1% | No (3/3) | No (3/3) | Yes (3/3) |
| 1.6% | No (3/3) | No (3/3) | Yes (3/3) |
| 0.8% | No (3/3) | No (3/3) | Yes (3/3) |
| 0.4% | No (3/3) | No (3/3) | — |
| 0.2% | No (3/3) | No (3/3) | — |
| 0.1% | No (3/3) | Yes (3/3) | — |
| 0.05% | No (3/3) | Yes (3/3) | — |

Note:
“Yes (N1/N2)/No (N1/N2)” on the above table represents N1 out of N2 samples have/do not have bacterial growth on agar plates; “—” represents not determined.

The foregoing indicates that the MBCs against S. epidermidis for the polymer compositions described in Example 21 are as follows:

| | | | Example 3 |
|---|---|---|---|
| | HDTMA = | HDTMA = | polymer |
| Species | SDS | 1/10 SDS | composition |
| MBC | ≦0.05% | 0.2% | >3.1% |

### EXAMPLE 23

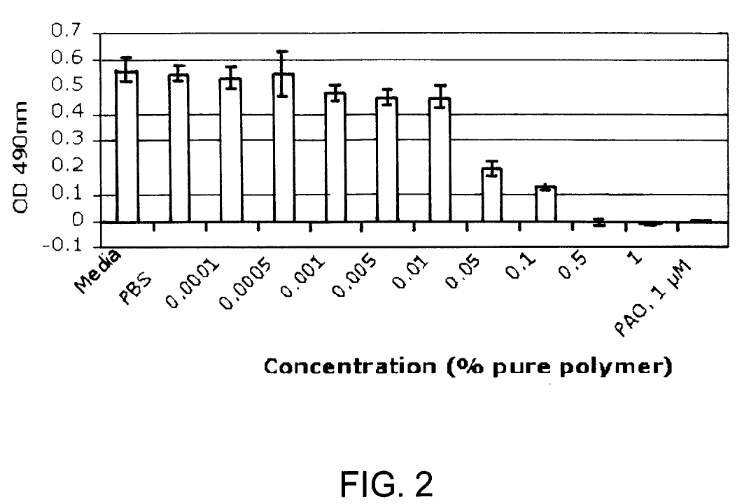

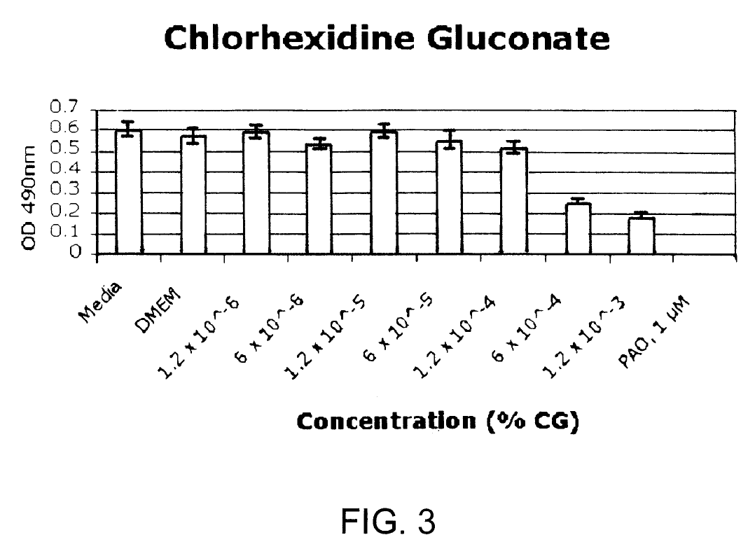

The toxicity of Example 1 is compared to Chlorohexidine gluconate (a commonly used oral antiseptic) to human HeLa cells in culture is determined. HeLa cells are plated at subconfluency into a 96-well plate tissue culture plate, and after attachment, treated with the indicated final concentrations of Example 1 polymer or Chlorohexidine gluconate in triplicates. After 48 hours of culture, MTT reagent is added for two 2 hours to permit the development of viability-indicating color. 1 μM PAO (phenylarsine oxide) is used as a positive (effective killing) control. Lethal dose 50 (LD₅₀) of Example 1 for HeLa cells is found to be ˜0.025% and for chlorohexidine gluconate ˜0.0004%. Furthermore, the minimum inhibitory concentration of Example 1 polymer is found to be about 10⁻³% while that for the chlorohexidine gluconate is 6×10⁻⁵%. This means that the Example 1 polymer is about 100 times less toxic to HeLa cells in culture than chlorohexidine gluconate. This is shown in FIGS. 2 and 3. These results indicate that for the polymer composition from Example 1 (FIG. 2): 0.01%<LD₅₀<0.05%; and MIC=1×10⁻³%. For chlorohexidine gluconate (FIG. 3): 1.2×10⁻⁴%<LD₅₀<6×104%; MIC=6×10⁻⁵%. This shows that the polymer composition from Example 1 is about 100 times less toxic that chlorohexidine gluconate.

### EXAMPLE 24

The inhibitory effect of the polymer against viral infectivity in is determined. 100 μl of polymer composition from Example 4 and 200 μl Dulbecco's Modified Eagle's Medium with 10% fetal bovine serum (DMEM-FCS) are mixed are placed in a well. Three-fold dilutions thereof using DMEM-FCS are prepared: 20.0%, 13.32%, 8.87%, 5.91%, 3.93%, 2.62%, 1.75%, 1.16%, 0.77%, 0.52%, 0.34%, and 0% (containing no polymer composition) and added to a 96 well tissue culture plate in 8 parallel rows. The polymer compositions are maintained in the wells at room temperature under a sterile hood for 24 hours. The polymer compositions dry to form film layers. The film layers are peeled off and rehydrated in 100 μl sterile nanopure water.

100 μl of pox virus (˜10²) and 200 μl LB are placed in a well and mixed. Three-fold dilutions thereof using DMEM-FCS are prepared, 10², 6.66², 4.44², 2.95², 1.97², 1.31², 8.72, and 0 (containing no virus) and added to a 96 well tissue culture plate in 12 parallel rows.

Test samples are prepared by mixing 50 μl of the diluted polymer compositions with 50 μl of viral concentrations into a well containing 100 μl (DMEM-FCS) and new tissue culture pre-seeded with HeLa cells (˜10⁴/well).

The plate is incubated for 1-4 days, media replaced with 100 μl methycellulose-containing DMEM-FCS and the incubation continued for additional 2-6 days. The pathologic effect of the virus is visually assessed for each column and row to determine the fold protective effect of the polymer as compared to the controls.

As viruses replicate in a cell, they spread to neighbor cells that have membrane contact. The infected cells will die resulting in plaque forming units (PFU) surrounded by living cells. The formation of plaques in living cells indicates the virus has survived and is killing the cells. Other viruses can take up to one week to show the development of PFU. One plaque forming unit indicates the polymer composition concentration did not prevent the virus from being pathogenic.

### EXAMPLE 25

The potential for using a change in polymer color or fluorescence as an indicator of dryness is determined. The polymer composition from Example 1 (containing McCormick blue food coloring) or polymer composition from Example 4 (containing Spectrazurine blue FGND-LIQ) is dried on a glass surface. Upon thorough drying, the gel with McCormick blue food coloring fluoresces bright red under UV light. This method of identifying if the polymer composition is fully dried is important when drying affects killing efficacy.

### EXAMPLE 26

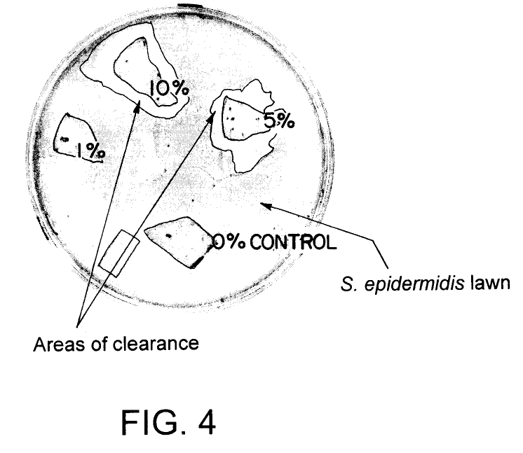

The inhibitory effect of a polymer that leaches out of a solid material (e.g. semi-solid) agarose is determined. 1 ml of 1% agarose, containing the polymer composition from Example 1 diluted to a final concentration of 10%, 5%, 1% or 0%, is allowed to harden. Segments of these materials are then placed on an LB plate that had been inoculated with ˜10⁵ S. epidermidis bacteria, the plate incubated at 37° C. overnight so that the bacterial lawn forms where the conditions are conducive to cell viability and replication. A ring of clearance around the agarose indicates that the polymer has leached out of the agarose and protected the surrounding area from being populated by the bacteria. This is shown in FIG. 4 which indicates that the polymer composition at 5% and 10% leaches out of a semi-solid support (1% agarose) and protects the surrounding area against proliferation of S. epidermis bacteria.

### EXAMPLE 27

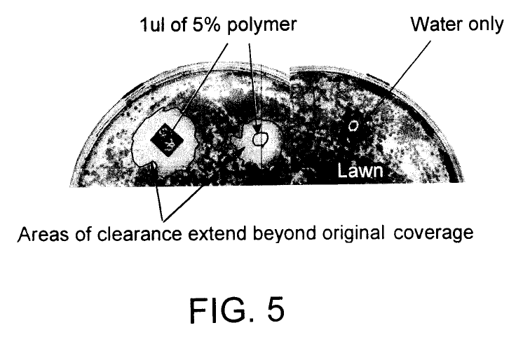

The inhibitory effect of an Example 1 polymer that leaches out of a solid material is determined. A series of ˜3 mm by 3 mm cellulose filter paper fragments (Whatmann) are placed on a surface of an LB plate that had been inoculated with ˜10⁵ unknown bacteria (likely many different species) that had grown out of partially cleaned Socorro sewage water. 1 ul of Example 15% (in water) polymer dilution, or water only, is spotted on top of the filter. The plate incubated at 37° C. overnight so that the bacterial lawn forms where the conditions are conducive to cell viability and replication. A ring of clearance around the filter paper indicates that the polymer has leached out of the filter paper and protected the surrounding area from being populated by the multiplicity of unknown environmental bacteria. Lack of bacterial cell growth in the area that was spotted with the polymer directly not only illustrates that the polymer prevents bacteria from proliferating where the 1 ul of the polymer contacted the inoculated surface, but that the protective effect leaches out & is greater than the area covered by the 1 ul of the polymer fluid. This example also illustrates that the Example 1 polymer needs not dry to inhibit bacterial growth effectively (since the plate is kept moist throughout the incubation period). The results are shown in FIG. 5 wherein the polymer composition at 5% leaches out of a solid support and protects the surrounding area against proliferation from unknown sewage bacteria.

### EXAMPLE 28

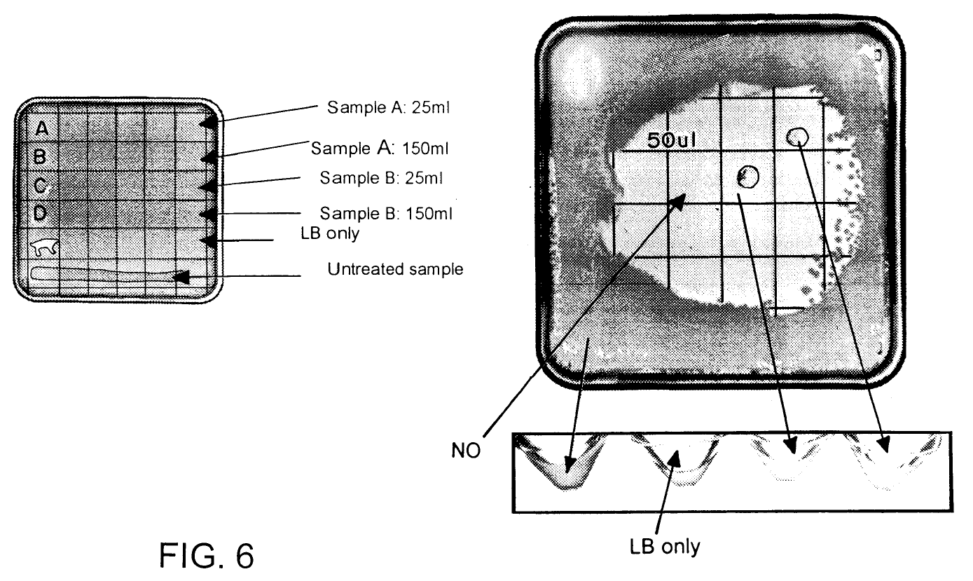

The inhibitory effect of the polymer composition from Example 1 that spreads over a moist surface that is conductive to germination of B. subtilis spores is determined. 50 μl of the polymer from Example 1 is spotted on top of an LB that is inoculated with 10⁵ B. subtilis spores. The plate is incubated (covered, kept moist) at 37° C. overnight. Where the conditions are conducive to spore germination and bacterial replication, a lawn is formed. A large ring of clearance seen not just under but also around the area directly covered by the polymer indicates that the polymer has protected the surface underneath itself and that the protective action leached out of the polymer and additionally protected the surrounding area from being populated by B. subtilis bacteria. This is shown in FIG. 6. This example shows that the polymer composition from Example 1 does not need to dry to inhibit spore germination and subsequent bacterial proliferation since the plate is kept moist throughout the incubation period. FIG. 6 shows killing of bacterial spores and prevention of the germinated B. subtilis bacteria. Area A is covered by the polymer. Area B is not covered by the polymer. Small (˜5 μl) samples of areas A and B are placed either into 25 ml or 150 ml of nutrient media to dilute out the polymer and allow bacterial outgrowth upon incubation at 37° C. for 48 hours. No growth is observed. To verify, 10 μl of each of the media (after 48 hour incubation) are streaked onto an LB plate. If there are any viable spores or planktoninc bacteria left in the area of clearance, colonies would form. No colonies formed, indicating that areas A and B are sterile. A control, polymer-unexposed cells, produces a thick streak of colonies.

While the invention has been explained in relation to various embodiments, it is to be understood that various modifications thereof may become more apparent to those skilled in the art upon reading this specification. Therefore, it is to be understood that the invention includes all such modifications that may fall within the scope of the appended claims.

1. A method, comprising: contacting a microorganism and/or an infectious agent with an effective amount of a polymer composition to reduce or eliminate the reproductivity, metabolism, growth and/or pathogenicity of the microorganism and/or infectious agent; the polymer composition comprising water, a water-soluble film forming polymer, a chelating agent, and a surfactant.

2. The method of claim 1 wherein the microorganism comprises bacteria, rickettsia, protozoa, fungi, plant, animal, or a mixture of two or more thereof.

3. The method of claim 1 wherein the microorganism comprises bacteria, fungus, yeast, yeast biofilm, mold, protist, or a mixture of two or more thereof.

4. The method of claim 1 wherein the microorganism comprises one or more spores.

5. The method of claim 1 wherein the infectious agent comprises a pathogen.

6. The method of claim 1 wherein the infectious agent comprises a virus, prion, rickettsia, or a mixture of two or more thereof.

7. The method of claim 1 wherein the polymer comprises repeating units derived from vinyl alcohol and/or (meth)acrylic acid.

8. The method of claim 1 wherein the polymer comprises polyvinyl alcohol, a copolymer of vinyl alcohol, or a mixture thereof.

9. The method of claim 1 wherein the polymer further comprises repeating units represented by the formula —CH₂—CH(OCOR)— wherein R is an alkyl group.

10. The method of claim 1 wherein the polymer further comprises repeating units derived from vinyl acetate.

11. The method of claim 1 wherein the polymer comprises a copolymer containing repeating units derived from vinyl alcohol and/or (meth)acrylic acid, and repeating units derived from one or more of ethylene, propylene, acrylic acid, methacrylic acid, acrylamide, methacrylamide, dimethacrylamide, hydroxyethylmethacrylate, methyl methacrylate, methyl acrylate, ethyl acrylate, vinyl pyrrolidone, hydroxyethylacrylate, allyl alcohol, hydroxymethylcellulose, hydroxethylcellulose, or a mixture of two or more thereof.

12. The method of claim 1 wherein the polymer comprises polyvinyl alcohol, the polymer having a molecular weight in the range from about 10,000 to about 150,000 g/mole, and a hydrolysis level in the range from about 70% to about 90%.

13. The method of claim 1 wherein the chelating agent comprises an organic compound that contains a hydrocarbon linkage and two or more functional groups, the functional groups comprising one or more of ═O, —OR, —NR₂, —NO₂, ═NR, ═NOR or ═NR*OR wherein R is H or alkyl and R* is alkylene.

14. The method of claim 1 wherein the chelating agent comprises an organic compound that contains a hydrocarbon linkage and two or more functional groups, the functional groups comprising one or more phosphate and/or phosphonate groups.

15. The method of claim 1 wherein the chelating agent comprises diethylenetriaminepentaacetic acid, ethylenediaminetetraacetic acid, Prussian Blue, citric acid, a peptide, an amino acid, and aminopolycarboxylic acid, gluconic acid, glucoheptonic acid, an organophosphonate, a bisphosphonate, an inorganic polyphosphate, a salt of any of the foregoing, or a mixture of two or more of the foregoing,

16. The method of claim 1 wherein the surfactant comprises one or more polysiloxanes, alkanolamines, alkylarylsulfonates, amine oxides, poly(oxyalkylene) compounds, block copolymers comprising alkylene oxide repeat units, carboxylated alcohol ethoxylates, ethoxylated alcohols, ethoxylated alkyl phenols, ethoxylated amines and amides, ethoxylated fatty acids, ethoxylated fatty esters and oils, fatty esters, fatty acid amides, glycerol esters, glycol esters, sorbitan esters, imidazoline derivatives, lecithin and derivatives, lignin and derivatives, monoglycerides and derivatives, olefin sulfonates, phosphate esters and derivatives, propoxylated and ethoxylated fatty acids or alcohols or alkyl phenols, sorbitan derivatives, sucrose esters and derivatives, sulfates or alcohols or ethoxylated alcohols or fatty esters, sulfates or sulfonates of dodecyl and/or tridecyl benzenes or condensed naphthalenes or petroleum, sulfosuccinates and derivatives, tridecyl or dodecyl benzene sulfonic acid, or a mixture of two or more thereof.

17. The method of claim 1 wherein the surfactant comprises a centrimonium cation, a hexadecyltrimethyl ammonium cation, or a mixture thereof.

18. The method of claim 1 wherein the surfactant comprises sodium dodecyl sulfate, sodium lauryl sulfate, cetyltrimethyl ammonium bromide, cetyltrimethyl ammonium chloride, hexadecyl trimethyl ammonium bromide, hexadecyl trimethyl ammonium chloride, or a mixture of two or more thereof.

19. The method of claim 1 wherein the polymer composition further comprises one or more crosslinkers, soaps, detergents, thixotropic additives, pseudoplastic additives, rheology modifiers, anti-sagging agents, anti-settling agents, leveling agents, defoamers, colorants, organic solvents, plasticizers, viscosity stabilizers, biocides, viricides, fungicides, chemical warfare agent neutralizers, humectants, or a mixture of two or more thereof.

20. The method of claim 1 wherein the polymer composition comprises: water; polyvinyl alcohol; diethylentriaminepentaacetic acid and/or a sodium salt thereof; and one or more of sodium dodecyl sulfate, sodium lauryl sulfate, cetyltrimethyl ammonium bromide, cetyltrimethyl ammonium chloride, hexadecyl trimethyl ammonium bromide, or hexadecyl trimethyl ammonium chloride.

21. The method of claim 1 wherein the polymer composition is characterized by the absence of an effective amount of an added biocide, viricide and/or fungicide to reduce or eliminate the reproductivity, metabolism and/or growth of the microorganism and/or infectious agent.

22. The method of claim 1 wherein the polymer composition is applied to the microorganism and/or infectious agent and allowed to dry.

23. The method of claim 1 wherein the microorganism and/or infectious agent is on a substrate, the process comprising applying the polymer composition to the substrate in contact with the microorganism and/or infectious agent, and drying the polymer composition to form a film.

24. The method of claim 23 wherein the film is removed from the substrate.

25. The method of claim 24 wherein the film is peeled off the substrate.

26. The method of claim 24 wherein a composition comprising water is applied to the film and the film is removed from the substrate.

27. The method of claim 24 wherein the film is removed from the substrate using a cleaning composition comprising water.

28. The method of claim 24 wherein the film is dispersed in a liquid and analyzed.

29. The method of claim 28 wherein the film is analyzed using polymerase chain reaction analysis, restriction enzyme analysis, cloning and/or nucleotide sequence analysis, and/or amino acid sequence analysis.

30. The method of claim 1 wherein the microorganism and/or infectious agent is in a liquid medium, the process comprising adding the polymer composition to the liquid medium.

31. The method of claim 1 wherein the polymer composition is applied to a substrate and the microorganism and/or infectious agent subsequently contacts the polymer composition.

32. The method of claim 31 wherein the polymer composition dries on the substrate and forms a film prior to being contacted by the microorganism and/or infectious agent.

33. The method of claim 31 wherein the polymer composition dries to form a film, and the microorganism and/or infectious agent contact the film for an effective period of time to reduce or eliminate the reproductivity, metabolism, growth and/or pathogenicity of the microorganism and/or infectious agent.

34. The method of claim 33 wherein the film is peeled off the substrate.

35. The method of claim 33 wherein the film is removed from the substrate using a composition comprising water.

36. The method of claim 1 wherein the microorganism comprises one or more of Escherichia coli, Escherichia coli O157:H7, Staphylococcus epidermidis, Staphylococcus epidermidis biofilms, Staphylococcus aureus, Staphylococcus aureus MRSA, Burkholderia cepacia, Bacillus subtilis, Enterococcus faecalis, Enterococcus faecalis-VRE, Pseudomonas aeruginosa, Pseudomonas aeruginosa biofilms, Streptococcus pyogenes, Acinetobacter baumannii, Candida albicans, or Candida albicans biofilms.

37. The method of claim 1 wherein microorganisms and/or infectious agents near the microorganisms and/or infectious agents contacted by the polymer composition have their reproductivity, metabolism, growth and/or pathogenicity reduced or eliminated.

38. A method comprising contacting a microorganism and/or an infectious agent with an effective amount of a polymer composition to reduce or eliminate the reproductivity, metabolism, growth and/or pathogenicity of the microorganism and/or infectious agent; the polymer composition comprising water, a water-soluble film forming polymer, a chelating agent, and a surfactant; the polymer composition being characterized by the absence of an effective amount of added biocide, viricide and/or fungicide to reduce or eliminate the reproductivity, metabolism, growth and/or pathogenicity of the microorganism and/or infectious agent.

39. A method, comprising: contacting a substrate with a polymer composition comprising water, a water-soluble film forming polymer, a chelating agent, and a surfactant; drying the polymer composition to form a polymer film adhered to the substrate; separating the polymer film from the substrate; forming a biofilm on the substrate; and separating the biofilm from the substrate.

40. A method, comprising: contacting a substrate with a polymer composition comprising water, a water-soluble film forming polymer, a chelating agent, and a surfactant; drying the polymer composition to form a polymer film adhered to the substrate; forming a biofilm on the polymer film; and separating the biofilm from the polymer film or separating the biofilm and the polymer film from the substrate.
